(19) United States
(12) Patent Application Publication
(10) Pub. No.: US 2009/0246392 A1
(43) Pub. Date: Oct. 1, 2009

(54) POLYAMIC ACID COMPOSITION, POLYIMIDE ENDLESS BELT AND MANUFACTURING METHOD THEREOF, AND IMAGE FORMING APPARATUS

(75) Inventor: Tsuyoshi MIYAMOTO, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., Tokyo (JP)

(21) Appl. No.: 12/262,843

(22) Filed: Oct. 31, 2008

(30) Foreign Application Priority Data
Mar. 26, 2008 (JP) 2008-081998

(51) Int. Cl. B05D 3/02; C08L 79/00

(52) U.S. Cl. 427/385.5; 524/600

(57) ABSTRACT

The present invention provides a polyamic acid composition in which carbon black with a pH value approximately 7 or less is dispersed in a solution comprising a polyamic acid represented by Formula (1) having amino groups at molecular terminal ends thereof, and a solvent.

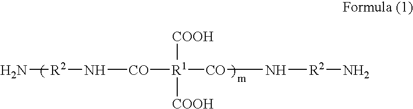

In Formula (1), R¹ represents a tetravalent organic group, R² represents a divalent organic group, and m represents an integer of 1 or more.

### CROSS-REFERENCE TO RELATED APPLICATION

This application is based on and claims priority under 35 USC 119 from Japanese Patent Application No. 2008-081998 filed Mar. 26, 2008.

### BACKGROUND

1. Technical Field

The invention relates to a polyamic acid composition, a polyimide endless belt and a manufacturing method of the polyimide endless belt, and an image forming apparatus.

2. Related Art

In an image forming apparatus using an electrophotographic system, an image holding member which is a photoreceptor including an inorganic or organic material is charged by forming electric charges on the surface thereof, and after a static latent image is formed by irradiation with a laser beam or the like modulated with image signals, the static latent image is developed with charged toner to obtain a visible toner image. The toner image is electrostatically transferred, through an intermediate transfer body or directly, onto a recording medium such as a paper to obtain a desired reproduced image.

Further, in an image forming apparatus in which an image is directly transferred electrostatically onto a recording medium such as a recording paper, a transfer conveyance belt system in which a transfer material is conveyed by being adhered via suction to an endless belt has been proposed and implemented, mainly for tandem type color image forming apparatuses and the like in which are arranged plural photoreceptors equipped with a developing unit for each color.

### SUMMARY

One aspect of the invention provides a polyamic acid composition in which carbon black with a pH value of approximately 7 or less is dispersed in a solution containing at least a polyamic acid represented by the following Formula (1) having amino groups at molecular terminal ends thereof, and a solvent.

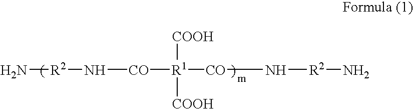

In Formula (1), R¹ represents a tetravalent organic group, R² represents a divalent organic group, and m represents an integer of 1 or more.

### BRIEF DESCRIPTION OF THE DRAWINGS

Exemplary embodiments of the present invention will be described in detail based on the following figures, wherein:

FIG. 1A is a schematic plan view illustrating one example of a circular electrode for measuring surface resistivity;

FIG. 1B is a schematic sectional view illustrating one example of a circular electrode for measuring surface resistivity;

FIG. 2 is a schematic configuration diagram illustrating one example of an image forming apparatus of the exemplary embodiment of the invention; and

FIG. 3 is a schematic configuration diagram illustrating another example of an image forming apparatus of the exemplary embodiment of the invention.

### DETAILED DESCRIPTION

Hereinafter, exemplary embodiments of the present invention will be explained.

Polyamic Acid Composition

The polyamic acid composition of one exemplary embodiment of the present invention is a polyamic acid composition in which carbon black with a pH value of approximately 7 or less (which may hereinafter be referred to as “acidic carbon black”) is dispersed in a solution containing at least a polyamic acid (which may hereinafter be referred to as a “specific polymer acid”) represented by the following Formula (1) having amino groups at molecular terminal ends thereof, and a solvent. Since the molecular terminal ends of the polyamic acid represented by Formula (1) are amino groups, the acidic carbon black can be well dispersed.

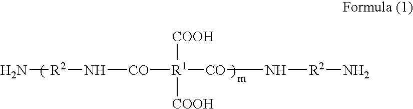

In Formula (1), R¹ represents a tetravalent organic group, R² represents a divalent organic group, m represents an integer of 1 or more, and preferably an integer of from 1 to 1000.

Polyamic Acid

First, the specific polyamic acid will be explained.

In Formula (1), R¹ represents a tetravalent organic group. The tetravalent organic group is preferably a residual structure in which four carboxylic acid groups are removed from a tetracarboxylic acid compound having the following structure:

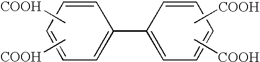

The groups having a residual group, in which four carboxyl groups are removed from the above tetracarboxylic acid compound, are more preferably groups having the following structures:

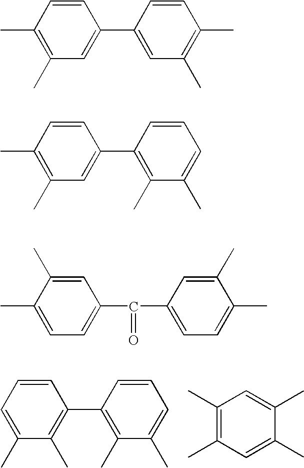

In Formula (1), R² represents a divalent organic group. Examples of the divalent organic group include a group having a residual group in which two carboxyl groups are removed from a diamic acid compound, and preferable examples thereof include the following groups having the following structures:

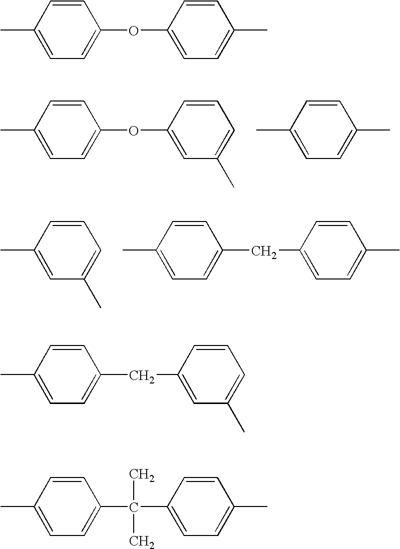

The specific polyamic acid can be obtained by polymerizing a tetracarboxylic dianhydride and a diamine compound in an organic polar solvent, with the diamine compound being in excess. In such a reaction, the molar ratio of the tetracarboxylic dianhydride to the diamine compound (molar quantity of tetracarboxylic dianhydride to molar quantity of diamine compound) is preferably in a range of from approximately 0.50 to approximately 0.99, and more preferably in a range of from approximately 0.80 to approximately 0.985. When the molar ratio is less than approximately 0.50, a polyimide resin prepared by the polyamic acid composition may have a low molecular weight, and the dynamic performance may become deteriorated when a polyimide endless belt is formed from the resin, and when the molar ratio exceeds approximately 0.99, the interaction of the polyamic acid with acidic carbon black may be reduced.

Tetracarboxylic Dianhydride

Tetracarboxylic dianhydrides which may be used in production of the specific polyamic acid are not particularly limited, and any of aromatic and aliphatic compounds may be used.

Examples of the aromatic tetracarboxylic dianhydride include pyromellitic dianhydride, 3,3′,4,4′-benzophenonetetracarboxylic dianhydride, 3,3′,4,4′-biphenylsulfonetetracarboxylic dianhydride, 1,4,5,8-naphthalenetetracarboxylic dianhydride, 2,3,6,7-naphthalenetetracarboxylic dianhydride, 3,3′,4,4′-biphenyl ether tetracarboxylic dianhydride, 3,3′,4,4′-dimethyldiphenylsilanetetracarboxylic dianhydride, 3,3′,4,4′-tetraphenylsilanetetracarboxylic dianhydride, 1,2,3,4-furantetracarboxylic dianhydride, 4,4′-bis(3,4-dicarboxyphenoxy)diphenyl sulfide dianhydride, 4,4′-bis(3,4-dicarboxyphenoxy)diphenyl sulfone dianhydride, 4,4′-bis(3,4-dicarboxyphenoxy)diphenylpropane dianhydride, 3,3′,4,4′-perfluoroisopropylidenediphthalic dianhydride, 3,3′,4,4′-biphenyltetracarboxylic dianhydride, bis(phthalic)phenylphosphine oxide dianhydride, p-phenylene-bis(triphenylphthalic)dianhydride, m-phenylene-bis(triphenylphthalic)dianhydride, bis(triphenylphthalic)-4,4′-diphenyl ether dianhydride, bis(triphenylphthalic)-4,4′-diphenylmethane dianhydride and the like.

Examples of the aliphatic tetracarboxylic dianhydride include aliphatic or alicyclic tetracarboxylic dianhydrides such as butanetetracarboxylic dianhydride, 1,2,3,4-cyclobutanetetracarboxylic dianhydride, 1,3-dimethyl-1,2,3,4-cyclobutanetetracarboxylic dianhydride, 1,2,3,4-cyclopentanetetracarboxylic dianhydride, 2,3,5-tricarboxycyclopentylacetic dianhydride, 3,5,6-tricarboxynorbornane-2-acetic dianhydride, 2,3,4,5-tetrahydrofurantetracarboxylic dianhydride, 5-(2,5-dioxotetrahydrofural)-3-methyl-3-cyclohexene-1,2-dicarboxylic dianhydride, bicyclo[2,2,2]-oct-7-ene-2,3,5,6-tetracarboxylic dianhydride or the like; and aliphatic tetracarboxylic dianhydrides having an aromatic ring such as 1,3,3a,4,5,9b-hexahydro-2,5-dioxo-3-furanyl-naphtho[1,2-c]furan-1,3-dione, 1,3,3a,4,5,9b-hexahydro-5-methyl-5-(tetrahydro-2,5-dioxo-3-furanyl)-naphtho[1,2-c]furan-1,3-dione, 1,3,3a,4,5,9b-hexahydro-8-methyl-5-(tetrahydro-2,5-dioxo-3-furanyl)-naphtho[1,2-c]furan-1,3-dione, or the like.

The tetracarboxylic dianhydride is preferably an aromatic tetracarboxylic dianhydride, and is more preferably pyromellitic dianhydride, 3,3′,4,4′-benzophenonetetracarboxylic dianhydride and 3,3′,4,4′-biphenylsulfonetetracarboxylic dianhydride.

These tetracarboxylic dianhydrides may be used singly, or of two or more kinds thereof may be used in combination.

Diamine Compound

The diamine compound which may be used in production of a polyamic acid is not particularly limited as long as the diamine compound has two amino groups in the molecule structure thereof.

Examples of the diamine compound include aromatic diamines such as p-phenylenediamine, m-phenylenediamine, 4,4′-diaminodiphenylmethane, 4,4′-diaminodiphenylethane, 4,4′-diaminodiphenyl ether, 4,4′-diaminodiphenyl sulfide, 4,4′-diaminodiphenyl sulfone, 1,5-diaminonaphthalene, 3,3-dimethyl-4,4′-diaminobiphenyl, 5-amino-1-(4′-aminophenyl)-1,3,3-trimethylindan, 6-amino-1-(4′-aminophenyl)-1,3,3-trimethylindan, 4,4′-diaminobenzanilide, 3,5-diamino-3′-trifluoromethylbenzanilide, 3,5-diamino-4′-trifluoromethylbenzanilide, 3,4′-diaminodiphenyl ether, 2,7-diaminofluorene, 2,2-bis(4-aminophenyl)hexafluoropropane, 4,4′-methylene-bis(2-chloroaniline), 2,2′,5,5′-tetrachloro-4,4′-diaminobiphenyl, 2,2′-dichloro-4,4′-diamino-5,5′-dimethoxybiphenyl, 3,3′-dimethoxy-4,4′-diaminobiphenyl, 4,4′-diamino-2,2′-bis(trifluoromethyl)biphenyl, 2,2-bis[4-(4-aminophenoxy)phenyl]propane, 2,2-bis[4-(4-aminophenoxy)phenyl]hexafluoropropane, 1,4-bis(4-aminophenoxy)benzene, 4,4′-bis(4-aminophenoxy)-biphenyl, 1,3′-bis(4-aminophenoxy)benzene, 9,9-bis(4-aminophenyl)fluorene, 4,4′-(p-phenyleneisopropylidene)bisaniline, 4,4′-(m-phenyleneisopropylidene)bisaniline, 2,2′-bis[4-(4-amino-2-trifluoromethylphenoxy)phenyl]hexafluoropropane, or 4,4′-bis[4-(4-amino-2-trifluoromethyl)phenoxy]-octafluorobiphenyl; aromatic diamines having two amino groups connected to an aromatic ring and having a hetero atom other than a nitrogen atom of the amino group, such as diaminotetraphenylthiophene; and aliphatic diamines and alicyclic diamines such as 1,1-metaxylylenediamine, 1,3-propanediamine, tetramethylenediamine, pentamethylenediamine, octamethylenediamine, nonamethylenediamine, 4,4-diaminoheptamethylenediamine, 1,4-diaminocyclohexane, isophoronediamine, tetrahydrodicyclopentadienylenediamine, hexahydro-4,7-methanoindanylenedimethylenediamine, tricyclo[6,2,1,02.7]-undecylenedimethyldiamine, or 4,4′-methylenebis(cyclohexylamine).

The diamine compound is preferably p-phenylenediamine, 4,4′-diaminodiphenylmethane, 4,4′-diaminodiphenyl ether, 4,4′-diaminodiphenyl sulfide, and 4,4′-diaminodiphenyl sulfone. These diamine compounds may be used singly, or two or more kinds thereof may be used in combination.

Combination of Tetracarboxylic Dianhydride and Diamine Compound

The specific polyamic acid preferably contains an aromatic tetracarboxylic dianhydride and an aromatic diamine.

Solvent

Examples of a solvent for use in polymerization of the specific polyamic acid include an organic polar solvent and specifically include sulfoxide solvents such as dimethyl sulfoxide or diethyl sulfoxide; formamide solvents such as N,N-dimethylformamide or N,N-diethylformamide; acetamide solvents such as N,N-dimethylacetamide or N,N-diethylacetamide; pyrrolidone solvents such as N-methyl-2-pyrrolidone or N-vinyl-2-pyrrolidone; phenol solvents such as phenol, o-, m- or p-cresol, xylenol, phenol halideor or catechol; ether solvents such as tetrahydrofuran, dioxane or dioxolane; alcohol solvents such as methanol, ethanol or butanol; cellosolves such as butylcellosolve; hexamethylphosphoramide, γ-butyrolactone and the like. For use in polymerization of the specific polyamic acid, the organic polar solvent may be used singly, or two or more kinds thereof may be used in a mixture. The aromatic hydrocarbons such as xylene or toluene may also be used. The solvent for use in polymerization of the specific polyamic acid is not particularly limited as long as the solvent can dissolve polyamic acids.

While the solid content of a polyamic acid solution for use in polymerization of the specific polyamic acid is not particularly limited, the content is preferably from approximately 5% by weight to approximately 50% by weight, and is more preferably from approximately 10% by weight to approximately 30% by weight with respect to the total amount of the polyamic acid solution.

The reaction temperature for polymerization of the specific polyamic acid is preferably in a range of form approximately 0° C. to approximately 80° C.

Acidic Carbon Black

The acidic carbon black may be produced by imparting a carboxyl group, quinone group, lactone group, hydroxyl group or the like to the surface of a carbon black by an oxidation treatment thereof. Examples of the oxidation treatment may include an air oxidation method in which a carbon black is contacted with air in a high temperature atmosphere (for example, from approximately 300° C. to approximately 800° C.), a method in which a carbon black is reacted with nitrogen oxide or ozone under an ambient temperature (for example, approximately 25° C., applicable in the following descriptions), and a method in which air oxidation is carried out at a high temperature (for example, from approximately 300° C. to approximately 800° C.) and then ozone oxidation is carried out at a low temperature (for example, from approximately 20° C. to approximately 200° C).

Specifically, the acidic carbon black may be produced by a method such as a contact method. Examples of the contact method include a channel method, gas black method and the like. The acidic carbon black may also be produced by a furnace black method using gas or oil as a raw material. If necessary, a liquid phase oxidation treatment with nitric acid or the like may be carried out after performing these treatments.

While the acidic carbon black may be produced by a contact method, it is usually produced by a furnace method in a closed system. In a furnace method, only carbon black with a high pH and low volatility is usually produced, but the above-mentioned liquid phase oxidation treatment may be further performed to control the pH of the obtained carbon black. Thus, a carbon black which is produced by a furnace method and having a pH controlled to approximately 7 or lower by a posttreatment process, may also be used.

The pH value of the acidic carbon black is lower than approximately 7, preferably approximately 4.4 or less, and more preferably approximately 4.0 or less.

The pH value of the acidic carbon black can be determined by measuring an aqueous suspension of carbon black with a glass electrode. The pH value of the acidic carbon black may be controlled by controlling conditions such as the treating temperature or treating duration in an oxidation treatment process.

The content of a volatile matter in the acidic carbon black is preferably from approximately 1% by weight to approximately 25% by weight, more preferably from approximately 2% by weight to approximately 20% by weight, and still more preferably from approximately 3.5% by weight to approximately 15% by weight.

Specific examples of the acidic carbon black include: PRINTEX 150T (pH 4.5, volatile content 10.0% by weight), SPECIAL BLACK 350 (pH 3.5, volatile content 2.2% by weight), SPECIAL BLACK 100 (pH 3.3, volatile content 2.2% by weight), SPECIAL BLACK 250 (pH 3.1, volatile content 2.0% by weight), SPECIAL BLACK 5 (pH 3.0, volatile content 15.0% by weight), SPECIAL BLACK 4 (pH 3.0, volatile content 14.0% by weight), SPECIAL BLACK 4A (pH 3.0, volatile content 14.0% by weight), SPECIAL BLACK 550 (pH 2.8, volatile content 2.5% by weight), SPECIAL BLACK 6 (pH 2.5, volatile content 18.0% by weight), COLOR BLACK FW200 (pH 2.5, volatile content 20.0% by weight), COLOR BLACK FW2 (pH 2.5, volatile content 16.5% by weight) and COLOR BLACK FW2V (pH 2.5, volatile content 16.5% by weight) (all trade names, manufactured by Evonik Degussa Co., Ltd.); MONARCH 1000 (pH 2.5, volatile content 9.5% by weight), MONARCH 1300 (H 2.5, volatile content 9.5% by weight), MONARCH 1400 (pH 2.5, volatile content 9.0% by weight), MOGUL-L (pH 2.5, volatile content 5.0% by weight) and REGAL 400R (pH 4.0, volatile content 3.5% by weight) (all trade names, manufactured by Cabot Corporation); and the like.

The content of the specific carbon black in the polyamic acid composition is preferably from approximately 20 parts by weight to approximately 40 parts by weight, and more preferably from approximately 25 parts by weight to approximately 35 parts by weight, with respect to 100 parts by weight of a polyamic acid.

As a dispersing agent used for dispersing the specific carbon black when preparing the polyamic composition, any dispersing agent with a low molecular weight or high molecular weight may be used, and any dispersing agent selected from cationic agents, anionic agents, and nonionic agents may be used. Among these dispersing agents, a nonionic polymer is preferable.

Nonionic Polymer

Examples of the nonionic polymer include poly(N-vinyl-2-pyrrolidone), poly(N,N′-diethyl acrylazide), poly(N-vinylformamide), poly(N-vinylacetamide), poly(N-vinylphthalamide), poly(N-vinylsuccinic amide), poly(N-vinylurea), poly(N-vinylpiperidone), polyN-vinylcaprolactam), poly(N-vinyloxazoline) and the like. These nonionic polymers may be added singly, or two or more kinds thereof may be added in combination. According to an exemplary embodiment of the invention, poly(N-vinyl-2-pyrrolidone) is preferably used since dispersibility of carbon black may be improved thereby.

The content of the nonionic polymer in the specific polyamic acid composition is preferably from approximately 0.2 parts by weight to approximately 3 parts by weight with respect to 100 parts by weight of polyamic acid.

Hereinafter, an exemplary embodiment of a method for forming a polyimide resin layer using a polyamic acid composition of the invention as a precursor of the above-mentioned polyimide resin will be described.

The polyamic acid composition may be prepared as follows. First, a polyamic acid solution, which is a precursor of a polyimide resin, is prepared by polymerizing a tetracarboxylic dianhydride and a diamine compound in an organic solvent. The polyamic acid solution is purified by precipitating a polyamic acid by the addition of a poor solvent such as methanol, and then reprecipitating the polyamic acid. A polyamic acid solution may be also obtained by filtrating the precipitated polyamic acid, and then re-dissolving it into a solvent such as γ-butyrolactone.

Next, a conductive agent such as a carbon black is added, in an amount of from approximately 5 parts by weight to approximately 60 parts by weight with respect to 100 parts by dry weight of the polyamic resin.

The method for dispersing the carbon black and crushing its agglomerate is not limited, but includes physical methods such as stirring by a mixer or stirrer, or dispersion using a parallel roll or ultrasound, and chemical methods such as introducing a dispersing agent.

Solid Content of Polyamic Acid Composition

The solid content of the polyamic acid composition is not particularly limited, but a range for manifesting appropriate viscosity is selected, in order to facilitate a coating process when producing a polyimide endless belt. The preferable viscosity for coating is generally from approximately 1 Pa·s to approximately 100 Pa·s, and the solid content of the polyamic acid composition giving such viscosity is preferably from approximately 10% by weight to approximately 40% by weight with respect to 100 parts by weight of a coating solvent (such as an organic polar solvent). The viscosity is measured with the use of an E type viscometer, and the method of measurement is as follows:
The viscosity is measured an E type rotary viscometer (trade name: TV-20H, manufactured by Toki Sangyo Co., Ltd.) with a standard rotor (cone angle: 1° 34′×R24), at a measurement temperature of approximately 25° C. and a rotation frequency of 0.5 rpm (100 Pa·s or more) or 1 rpm (less than 100 Pa·s).

The solid content of the specific polyamic acid in the polyamic acid composition is preferably approximately 10% by weight or more to obtain a belt material of the desired thickness. The solid content of the specific polyamic acid is preferably approximately 15% by weight or more, and the upper limit of the content is approximately 50% by weight.

Polyimide Endless Belt and Manufacturing method of Polyimide Endless Belt

The polyimide endless belt of the exemplary embodiment of the invention can be obtained by coating the polyamic acid composition of the exemplary embodiment onto the surface of a cylindrical substrate, and converting the polyamic acid contained in the polyamic acid composition to an imide by subjecting the polyamic acid composition coated on the cylindrical substrate to a heat treatment. The polyimide endless belt of the exemplary embodiment of the invention may be manufactured by coating the polyamic acid composition of the exemplary embodiment of the invention on a cylindrical substrate, and subsequently preparing one surface of the polyimide endless belt by subjecting the polyamic acid composition to a drying treatment and a baking treatment, and then further treating the surface with a basic aqueous solution or an acidic aqueous solution.

Hereinafter, an exemplary embodiment of a manufacturing method of polyimide endless belt of the invention will be described.

First, the polyamic acid composition of the exemplary embodiment of the invention is coated onto the surface of a cylindrical substrate. As the cylindrical substrate for the exemplary embodiment of the invention, a cylindrical metal substrate is preferable, and molding dies made of various known materials such as a resin, a glass, or a ceramic may be also be preferably used.

Further, a glass coat or a ceramic coat may be provided on the surface of a substrate, and a silicone or fluorine releasing agent may also be used.

Further, a substrate for controlling film thickness which has been adjusted for clearance with respect to the cylindrical metal substrate is inserted into the cylindrical metal substrate and moved parallel thereto to expel excess solution and provide uniform thickness to a solution on the cylindrical metal substrate. If the solution has already been provided with uniform thickness at a stage of application of the solution to the cylindrical metal substrate, there is no need to use the substrate for controlling film thickness.

As the surface of the cylindrical substrate, both the inner surface and the outer surface of the cylindrical substrate can be used. If the inner surface of the substrate is coated with a polyamic acid composition, the outer surface of the belt, which is a functional surface of the polyimide endless belt to be formed, contacts the surface of the substrate, so that contamination from the substrate may arise, resulting in deterioration of the properties of the polyimide endless belt. On the other hand, if the outer surface of the substrate is coated with a polyamic acid composition, contamination from the substrate to the outer surface of the belt, which is a functional surface of the polyimide endless belt to be formed, may be prevented. However, in this case, the outer surface is formed such that the outer surface contacts the atmosphere in the steps of drying and baking. Accordingly, degradation of an electroconductive polymer due to oxidation, evaporation of a dopant and the like may arise in this outer surface. Therefore, it is necessary to take appropriate measures for each individual coating surface of the cylindrical substrate.

Coating Solvent

Examples of the coating solvent to be used in coating a polyamic acid composition on the surface of a cylindrical substrate include: sulfoxide solvents such as dimethyl sulfoxide or diethyl sulfoxide; formamide solvents such as N,N-dimethylformamide or N,N-diethylformamide; acetamide solvents such as N,N-dimethylacetamide or N,N-diethylacetamide; pyrrolidone solvents such as N-methyl-2-pyrrolidone or N-vinyl-2-pyrrolidone; phenol solvents such as phenol, o-, m- or p-cresol, xylenol, phenol halide, or catechol; ether solvents such as tetrahydrofuran, dioxane, or dioxolane; alcohol solvents such as methanol, ethanol, or butanol; cellosolves such as butylcellosolve;. hexamethylphosphoramide; and γ-butyrolactone. These solvents are preferably used singly, or as two or more kinds thereof may be used in a mixture. For the coating solvent, aromatic hydrocarbons such as xylene or toluene may also be used. The solvent for use in polymerization of the specific polyamic acid is not particularly limited as long as the solvent can dissolve polyamic acids or polyamic acid-polyimide copolymers.

The coating solvent may be used as a synthesis solvent in the polyamic acid synthesis. Alternatively, a synthesis solvent used in polyamic acid synthesis may be substituted by the coating solvent after polymerization of the polyamic acid. The substitution of the solvent may be carried out by any method, and examples thereof include a method in which a polyamic acid solution is diluted by adding a predetermined amount of solvent, a method in which a polymer is redissolved after being reprecipitated in a predetermined solvent, and a method in which a composition is adjusted by adding a predetermined solvent and gradually distilling the solvent off.

Next, the cylindrical substrate coated with the polyamic acid composition is placed in a heated environment, and dried in order to evaporate approximately 20% by weight or more, preferably approximately 60% by weight or more of the solvent contained therein. At this time, the solvent may remain in a coated layer, as long as the coated surface is dried and does not flow when the surface is tilted. The drying is preferably performed at temperatures of in a range of from approximately 50° C. to approximately 200° C.

After drying, the polyamic acid structure in the polyamic acid composition is converted to an imide. In this imidation reaction, the cylindrical substrate coated with the polyamic acid composition is preferably heated to a predetermined temperature, so that the imidation reaction is fully progressed. The heating temperature is from approximately 60° C. to approximately 200° C., and preferably from approximately 100° C. to approximately 170° C., and the temperature may vary depending on the kind of raw material used, such as tetracarboxylic dianhydride or diamine, and should be set at temperatures at which the imidation reaction can be completed. When imidation is insufficient, a mechanical property and an electrical property of a polyimide endless belt formed from the polyamic acid composition may be poor.

As the imidation reaction, the following chemical imidation may be performed. In the chemical imidation method, a dehydrating agent and/or a catalyst is added into a polyamic acid solution and an imidation reaction is progressed chemically. A dehydrating agent is not particularly limited as long as it is a monovalent carboxylic anhydride. For example, one or more compounds selected from acid anhydrides such as acetic anhydride, propionic anhydride, trifluoroacetic anhydride, butanoic anhydride or oxalic anhydride may be used. The amount of the dehydrating agent to be added is preferably from approximately 0.01 mol to approximately 2 mol with respect to 1 mol of repeating units of the polyamic acid.

As the catalyst, one or more compounds selected from pyridine, picoline, collidine, lutidine, quinoline, isoquinoline, or tertiary amines such as triethylamine may be used, but the catalyst is not limited to these. The amount of the catalyst to be added is preferably from approximately 0.01 mol to approximately 2 mol with respect to 1 mol of a dehydrating agent to be used.

This chemical imidation reaction is carried out by adding a dehydrating agent and/or a catalyst into a polyamic acid solution and, if necessary, heating the solution. The reaction temperature of dehydration cyclization is generally from approximately 0° C. to approximately 180° C. and preferably from approximately 60° C. to approximately 150° C.

The composition ratio of an imidated structure to an unreacted amic acid structure is not particularly limited as long as partial imidation is attained, but is preferably from approximately 0/100 (mol/mol) to approximately 80/20 (mol/mol). When the composition ratio of an imide group to an amic acid group is higher than approximately 80/20 (mol/mol), the polyamic acid-polyimide copolymer may not solubilize.

The dehydrating agent and/or catalyst that acts on a polyamic acid-polyimide copolymer does not have to be removed, but may be removed by the following method. As a method of removing the dehydrating agent and/or catalyst, a method of heating under reduced pressure or a reprecipitation method may be used. The heating under reduced pressure is carried out in a vacuum at a temperature of from approximately 80° C. to approximately 120° C., and using a tertiary amine is as a catalyst, an unreacted dehydrating agent and a hydrolyzed carboxylic acid are distilled off. The reprecipitation method is carried out by adding a reaction liquid to the large excess amount of poor solvent, which dissolves the catalyst, the unreacted dehydrating agent and hydrolyzed carboxylic acid, but does not dissolve a polyamic acid-polyimide copolymer. The poor solvent is not particularly limited, and water, alcohol solvents such as methanol or ethanol, ketone solvents such as acetone or methyl ethyl ketone, hydrocarbon solvents such as hexane, and the like, may be used. The deposited polyamic acid-polyimide copolymer is filtrated and dried, and then dissolved again in a solvent such as γ-butyrolactone or N-methyl-2-pyrrolidone.

In the imidation reaction, the conversion from the polyamic acid to a polyimide takes place by a dehydration cyclization reaction of the polyamic acid. As a result thereof, the weight equivalent to the amount of released water is lost, whereby the content ratio of the electroconductive polymer to the polyimide resin component in the polyimide endless belt increases, as compared with the content ratio of the electroconductive polymer to the polyamic acid resin component.

The resin is removed from the mold (substrate), whereby the polyimide endless belt can be obtained.

Although the production method of the polyimide endless belt of the present embodiment is explained above, the exemplary embodiment of the invention is not limited only to these embodiments, and can be carried out by implementing various improvements, modifications or variations to the embodiments based on the knowledge of a person skilled in the art, without departing from the scope of the invention. In addition, the polyimide endless belt of the exemplary embodiment of the invention can also be used as a roll, without removing it from a substrate.

Ten sample pieces cut off from a polyimide endless belt are measured under the conditions of a tensile load of 1.0 Kg and a bending angle of 135° by an MIT tester, and the number of times each test piece is bent reciprocally until it breaks (folding endurance number) (N), is obtained. In the polyimide endless belt of the exemplary embodiment of the invention, the average value FEₐᵥ of the folding endurance calculated from the following equation (A) based on the folding endurance number (N), and the average layer thickness (μm) of the ten sample pieces preferably satisfy the following equation (B). When the equation (B) is satisfied, the specific carbon black may be dispersed well, and as a result, the resistance may be stabilized.

FE=log ₁₀N Equation (A)

FEₐᵥ=ad+b Equation (B)

Here, in the equation (B), d represents an average layer thickness (μm) of the ten pieces of samples. a is from approximately −0.03667 to −approximately 0.03650. b is approximately 6.78 or more. d is from approximately 50 to approximately 150.

Measurement of the folding endurance number is performed as follows:

Ten test pieces (measuring 150 mm×15 mm) are cut off from the polyimide endless belt to be measured. At this time, the thickness of the belt is adjusted by controlling coating conditions in various ways so that the layer thickness is from 50 μm to 150 μm. The ten test pieces are cut off from the polyimide endless belt to obtain film-like test pieces 15 mm in width in accordance with JIS-C5016 (1994) (corresponding to IEC 249-1 (1982)), and the test pieces are measured under conditions of a tensile load of 1.0 Kg and a bending angle of 135°, and the number of times each test piece is reciprocally bent until it breaks (folding endurance number) (N) is obtained.

Each of the ten test pieces is measured in the above manner, and the number of times each piece is reciprocally bent until it breaks (folding endurance number) N is obtained, and the FE is calculated in accordance with the equation (A). Further, the average value of the FE values for the ten test pieces is calculated, and the average value is denoted as FEₐᵥ and it is checked whether FEₐᵥ satisfies the equation (B).

The thickness of the belt is measured by use of an eddy current type coating thickness meter (trade name: CTR-1500E, manufactured by Sanko Electronic Laboratory Co., Ltd.). The measurement is carried out five times for each test piece, and the average value thereof indicates the layer thickness of the belt.

Furthermore, in the polyimide endless belt of the exemplary embodiment of the invention, the compounding amount (C) (parts by weight) of the carbon black with a pH value of approximately 7 or less with respect to 100 parts of polyimide resin contained in the polyimide endless belt, and the surface resistivity ρs (log Ω/□) at 25° C. of the outer periphery of the polyimide endless belt preferably satisfy the following Equation (C). When Equation (C) is satisfied, aggregation of the specific carbon black may by avoided, which may reduce damage to the edge of the belt which occurs upon providing ribs.

ρs=pC+q Equation (C)

In Equation (C), p is from approximately −0.48 to approximately −0.42, and q is from approximately 25 to approximately 33. ρs is from approximately 8 to approximately 14, and C is from approximately 20 to approximately 40.

Measurement of the surface resistivity (ρs) of the outer periphery of the polyimide endless belt is performed as follows:

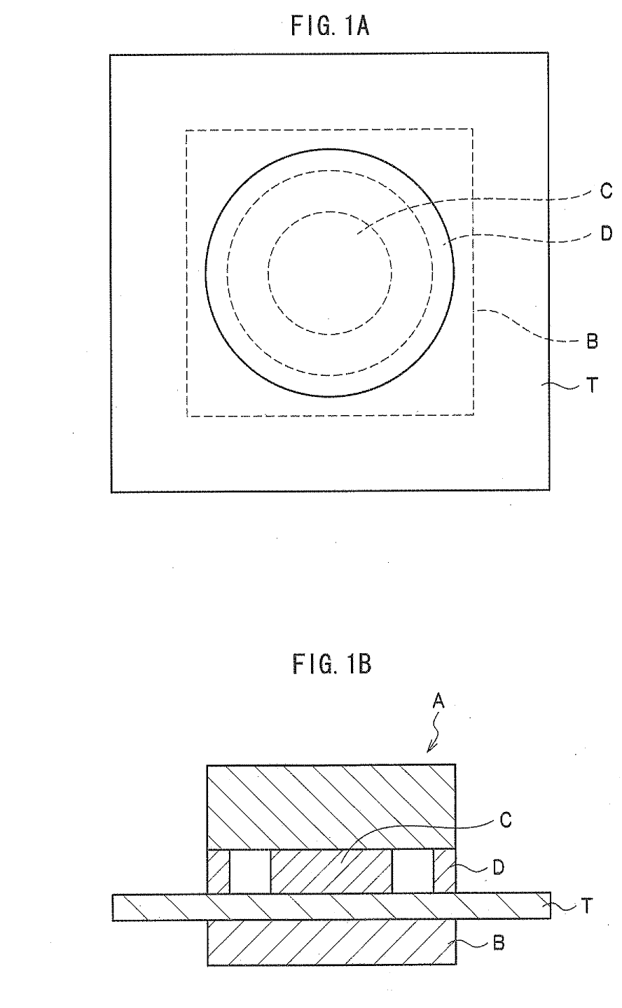

The surface resistivity is measured by using a cylindrical electrode (UR probe of HIRESTA IP manufactured by Mitsubishi Chemical Corporation: cylindrical electrode part C has an outer diameter Φ of 16 mm, ring-shaped electrode part D has an inner diameter Φ of 30 mm and an outer diameter Φ of 40 mm), as an electrode. Specifically, a common-logarithm value of surface resistivity (ρs) is calculated from the current value, which is obtained by measuring the current value after applying a voltage of 100V to the polyimide endless belt under an environment of 22° C./55% RH for 10 seconds. FIG. 1A is a schematic plan view illustrating one example of a circular electrode for measuring surface resistivity, and FIG. 1B is a schematic sectional view illustrating one example of a circular electrode for measuring surface resistivity.

The following is a detailed method for measuring surface resistivity:

The circular electrode shown in FIG. 1A and FIG. 1B has a first voltage application electrode A and a second voltage application electrode B. The first voltage application electrode A has a cylindrical electrode part C and a cylindrical ring-shaped electrode part D which has an inner diameter larger than the outer diameter of the cylindrical electrode part C and surrounds the cylindrical electrode part C. A test sample, a polyimide endless belt T, is sandwiched between the second voltage application electrode B, and the cylindrical electrode part C and the ring-shaped electrode part D of the first voltage application electrode A. The surface resistivity ρs (Log Ω/□) of the polyimide endless belt T is obtained by the following Equation (D), by measuring current I (A), which flows when voltage V (V) is applied between the cylindrical electrode part C and the ring-shaped electrode part D of the first voltage application electrode A.

ρs=π×(D+d)/(D−d)×(V/I) Equation (D)

In Equation (D), d (cm) represents the outer diameter of the cylindrical electrode C. D (cm) represents the inner diameter of the ring-shaped electrode D.

Image Forming Apparatus

An image forming apparatus of the exemplary embodiment of the invention mounts one or more endless belts and, among these endless belts, at least one is the polyimide endless belt of the exemplary embodiment of the invention. The endless belt according to the exemplary embodiment of the invention may have various uses, such as an intermediate transfer belt, a transfer delivery belt, or a fixing belt in electrophotographic image forming apparatuses such as electrophotographic copying machines, laser beam printers, facsimiles or composite devices thereof.

The endless belt is not particularly limited, as long as an outer peripheral surface of an endless belt a recording medium can be repeatedly contacted and peeled off during image formation and examples thereof include an intermediate transfer belt, a transfer conveyance belt and a fixing belt. As the endless belt, the endless belt of the exemplary embodiment of the invention may be used.

In a portion where an endless belt of the exemplary embodiment of the invention is used as an endless belt of an image forming apparatus, occurrence of paper clogging may be inhibited even under a low temperature and low humidity environment.

As a configuration of an image forming apparatus of the exemplary embodiment of the invention, any known configuration may be adopted as long as it mounts at least one endless belt.

A typical configuration of an image forming apparatus of the exemplary embodiment of the invention includes: an image holding member; a charging unit for charging a surface of the image holding member; an exposing unit for exposing a surface of the image holding member to form an electrostatic latent image; a developing unit for developing the electrostatic latent image formed on the surface of the image holding member with a developing agent to form a toner image; a transfer unit for transferring the toner image formed on the surface of the image holding member onto a recording medium; a fixing unit for fixing the toner image transferred onto a recording medium surface; and a cleaning unit for removing an adherent material such as a toner and dirt adhered on a surface of the image holding member after the toner image is transferred onto the recording medium, and other known units may be further provided as required.

In an image forming apparatus having the above configuration, when an intermediate transfer belt is used, a toner image is transferred by an intermediate transfer process. In this case, after a toner image formed on a surface of the image holding member is transferred on an outer peripheral surface of an intermediate transfer medium at a primary transfer portion, the transferred toner image is transported to a secondary transfer portion with the recording medium held at the outer peripheral surface of the intermediate transfer medium, and the toner image is transferred from the outer peripheral surface of the intermediate transfer medium to a recording medium at the secondary transfer portion.

In an image forming apparatus having the above configuration, when a transfer conveyance belt is used, after a toner image formed on a surface of the image holding member is transferred onto an outer peripheral surface of a transfer delivery belt, a recording medium is transported to a fixing unit by using the transfer delivery belt.

In an image forming apparatus having the above configuration, a fixing belt may also be used as the fixing unit. Although the fixing unit is provided with at least a pair of fixing members disposed faced so as to press each other, a fixing unit in which at least one of fixing members thereof is a fixing belt may be used.

Specific examples of the configuration of the fixing unit (fixing device) provided with a fixing belt include at least: one or more driving members; an endless belt (fixing belt) that can be driven and rotated by the one or more driving members; and a pressing member. In the fixing unit, a surface of any one of the one or more driving members and an outer peripheral surface of the endless belt are disposed in contact with each other, and the pressing member is disposed in contact with an inner peripheral surface of the endless belt and presses the endless belt towards the driving member so that a pressure contact portion is formed between a portion at which the inner peripheral surface of the endless belt contacts the pressing member and a portion at which the outer peripheral surface of the surface endless belt contacts the driving member.

If required, the fixing unit may have other configurations and functions in addition to the above-described configurations and functions, and, for example, a lubricant agent may be applied on the inner peripheral surface of an endless belt. As the lubricant agent, known liquid lubricant agents (such as silicone oil or the like) may be used. The lubricant agent may be applied continuously via a felt or the like provided in contact with the inner surface of an endless belt.

The fixing units may preferably control pressure distribution along the axis direction of an endless belt by the pressing member at a pressure contact portion. For example, when a lubricant agent is used, the distribution of the lubricant agent applied on the inner surface of an endless belt may be arbitrarily controlled by regulating the pressure distribution, such that the lubricant agent is drawn to one edge or to the center part of an endless belt. This may allow the excess lubricant agent to be collected to one edge of an endless belt and recovered, or to be moved to the center part of an endless belt, thereby pollution within the apparatus due to leakage of the lubricant agent from the edge of an endless belt may be prevented.

The control of pressure distribution is particularly useful when a lubricant agent is used, and further, when streaky irregular roughness is imparted to the inner surface of an endless belt to be used. In this case, the distribution of the lubricant agent applied on the inner surface of an endless belt may be easily controlled by regulating the pressure distribution at a pressure contact portion taking into account the direction of the streaks of the streaky irregular roughness.

Hereinafter, exemplary embodiments of the image forming apparatus of the invention will be described in detail with reference to the drawings. In the exemplary embodiments shown below, a fixing unit provided with a pair of fixing rolls is used, but a fixing unit in which at least one of the fixing rolls thereof is replaced by a fixing belt may also be used.

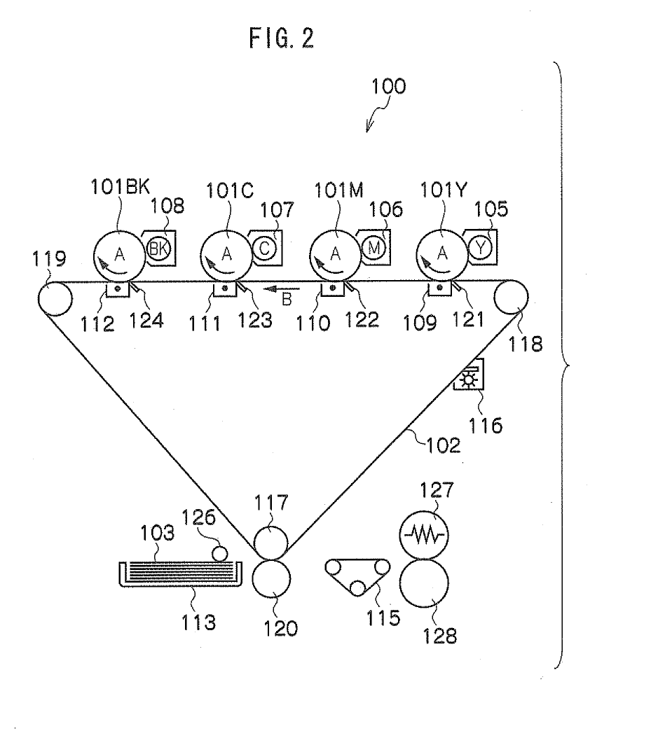

FIG. 2 is a schematic configuration diagram illustrating one example of an image forming apparatus of the exemplary embodiment of the invention. The image forming apparatus uses an endless belt of the exemplary embodiment of the invention as an intermediate transfer belt.

An image forming apparatus 100 shown in FIG. 2 is provided with photoreceptor drums 101Y, 101M, 101C and 101BK, and together with a rotation in a direction of an arrow A, an electrostatic latent image according to image data is formed on a surface thereof by a known electrophotographic process (not shown in the drawing; further, a charging unit and a cleaning unit are not shown in FIG. 2).

Developers 105 to 108 corresponding to the respective colors of yellow (Y), magenta (M), cyan (C) and black (BK) are disposed around the photoreceptor drums 101Y, 101M, 101C and 101BK, respectively, and electrostatic latent images formed on the photoreceptor drums 101Y, 101M, 101C and 101BK are developed by the respective developers 105 to 108 to form toner images.

For example, when an electrostatic latent image formed on the photoreceptor drum 101Y corresponds to yellow image data, the electrostatic latent image is developed by the developer 105 that contains a yellow (Y) toner to form a yellow toner image on the photoreceptor drum 101Y.

An intermediate transfer belt 102 is a belt shaped intermediate transfer belt disposed to contact with surfaces of the photoreceptor drums 101Y, 101M, 101C and 101BK, which is stretched by plural rolls 117 to 119, and which rotates in the direction arrow B.

The above endless belt of the exemplary embodiment of the invention is used as the intermediate transfer belt 102.

At respective primary transfer positions where the photoreceptor drums 101Y, 101M, 101C and 101BK and the intermediate transfer belt 102 come into contact, unfixed toner images formed on the photoreceptor drums 101Y, 101M, 101C and 101BK are sequentially transferred from the photoreceptor drums 101Y, 101M, 101C and 101BK onto a surface of the intermediate transfer belt 102 to form the superposed toner images of the respective colors.

At the primary transfer portion, corona discharge units 109 to 112 are disposed on a rear surface side of the intermediate transfer belt 102. In the corona discharge units 109 to 112, charging at contact regions before transfer is inhibited by use of shielding members 121 to 124, which prevent a transfer electric field from acting on an unnecessary region of the intermediate transfer belt 102. By applying a voltage having polarity opposite to the charging polarity of the toner to the corona discharge units 109 to 112, unfixed toner images on the photoreceptor drums 101Y, 101M, 101C and 101BK are electrostatically transferred onto an outer peripheral surface of the intermediate transfer belt 102. The primary transfer medium is not particularly limited to the corona discharge unit as long as it uses an electrostatic force, and may be a roll or a brush to which a voltage is applied.

Unfixed toner images primarily transferred on the intermediate transfer belt 102 are then transported by rotation of intermediate transfer belt 102 to a secondary transfer position facing a transportation path of a recording medium 103. At the secondary transfer position, a secondary transfer roll 120 and a rear surface roll 117 in contact with a rear surface side of the intermediate transfer belt 102, are disposed with the intermediate transfer belt 102 sandwiched therebetween.

A recording medium 103, delivered from a sheet feeder 113 at a predetermined timing by using a delivery roller 126, is inserted between, and passes through, at a contact portion of the secondary transfer roll 120 and the intermediate transfer belt 102. At this time, a voltage is applied at the contact portion of the secondary transfer roll 120 and the roll 117, and the unfixed toner images held on the intermediate transfer belt 102 are transferred onto the recording medium 103 at the secondary transfer position.

The recording medium 103 carrying thereon the transferred unfixed toner image is peeled off from the intermediate transfer belt 102, fed by a delivery belt 115 to between a heating roll 127 and a pressing roll 128 of a fixing unit, where the heating roll 127 and pressing roll 128 are provided in opposing positions, and the unfixed toner image is fixed. In this case, an apparatus configured to perform simultaneous transfer and fixation processes, by which a secondary transfer process and a fixation process are conducted simultaneously, may also be used.

The intermediate transfer belt 102 is provided with a cleaning unit 116. The cleaning unit 116 is disposed so as to detach freely from the intermediate transfer belt 102, and is separated from the intermediate transfer belt 102 until the secondary transfer is performed.

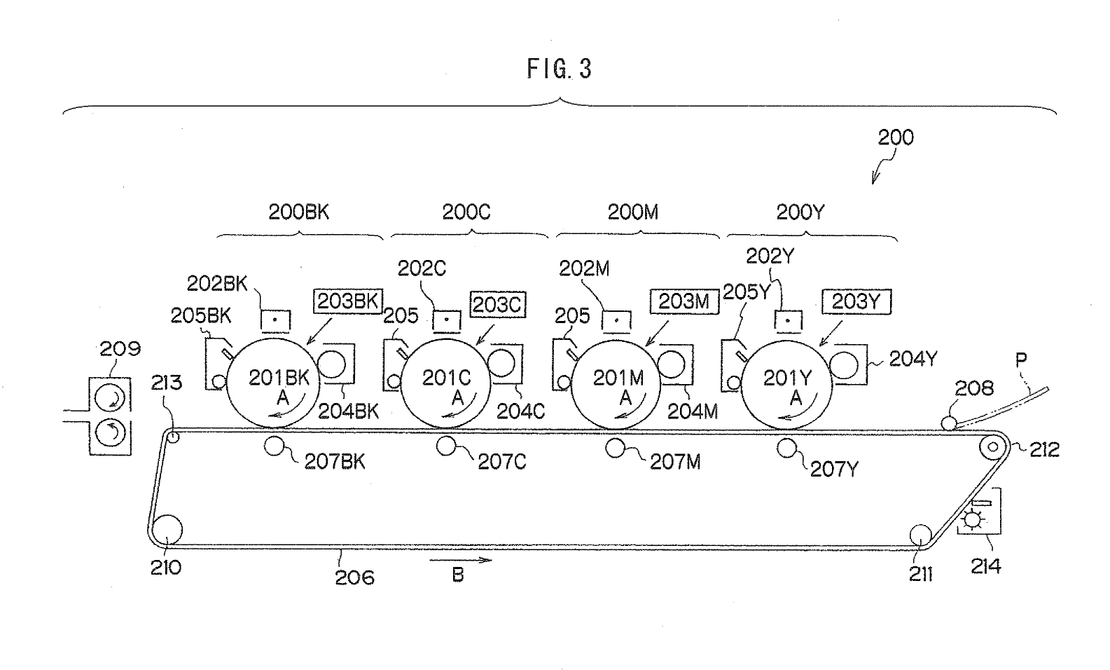

FIG. 3 is a schematic configuration diagram illustrating another example of an image forming apparatus of the exemplary embodiment of the invention. In the image forming apparatus, the above endless belt of the exemplary embodiment of the invention is used as a transfer delivery belt.

An image forming apparatus 200 shown in FIG. 3 includes: image forming units 200Y, 200M, 200C and 200Bk, each provided with a photoreceptor drum, a charging unit, a developer and a photoreceptor drum cleaner; a transfer delivery belt 206; transfer rolls 207Y, 207M, 207C and 207Bk; a recording medium delivery roller 208; and a fixing unit 209. As the transfer delivery belt 206, the endless belt of the exemplary embodiment of the invention is used.

In the image forming units 200Y, 200M, 200C and 200Bk, photoreceptor drums 201Y, 201M, 201C and 201Bk as image holding members are rotatably provided having a predetermined peripheral velocity in the direction of arrow A (a clockwise direction). Disposed around the photoreceptor drums 201Y, 201M, 201C and 201Bk are charging units 202Y, 202M, 202C and 202Bk, exposing units 203Y, 203M, 203C and 203Bk, developing units of respective colors (yellow developing unit 204Y, magenta developing unit 204M, cyan developing unit 204C and black developing unit 204Bk), and photoreceptor cleaners 205Y, 205M, 205C and 205Bk.

The image forming units 200Y, 200M, 200C and 200Bk are disposed parallel to the transfer delivery belt 206 in the positional order of 200Y, 200M, 200C, and 200Bk. However, the positional order thereof may be set as appropriate, depending on the method of image forming; for example, the positional order of 200Bk, 200Y, 200C, and 200M may be used.

The transfer delivery belt 206 is rotatable at the same peripheral velocity as the photoreceptor drums 201Y, 201M, 201C and 201Bk in the direction of arrow B (a counterclockwise direction) owing to supporting rolls 210, 211, 212 and 213. A part of the transfer delivery belt 206 situated at an intermediate position between supporting rolls 212 and 213 is disposed to contact with the photoreceptor drums 201Y, 201M, 201C and 201Bk, respectively. The transfer delivery belt 206 is provided with a belt cleaning apparatus 214.

Transfer rolls 207Y, 207M, 207C and 207Bk are disposed at an inner side of the transfer delivery belt 206 facing the contact portion of the transfer delivery belt 206 and the photoreceptor drums 201Y, 201M, 201C and 201Bk, respectively. Transfer regions for transferring toner images to recording media P via the transfer delivery belt 206 are formed between the photoreceptor drums 201Y, 201M, 201C and 201Bk, and the transfer rolls 207Y, 207M, 207C and 207Bk.

A fixing unit 209 is disposed so that the recording media P is delivered to the fixing unit after passing through respective transferring regions between the delivery belt 206 and the photoreceptor drums 201Y, 201M, 201C and 201Bk.

The recording media P is delivered to the transfer delivery belt 206 by a recording media delivery roll 208.

In the image forming unit 200Y, the photoreceptor drum 201Y is driven to rotate. A charging unit 202Y is driven in conjunction with the photoreceptor drum 201Y, thereby charging the surface of the photoreceptor drum 201Y with predetermined polarity and potential. The photoreceptor drum 201Y having the charged surface is, then, exposed in image-like fashion by the exposing unit 203Y to form an electrostatic latent image on its surface.

Subsequently, the electrostatic latent image is developed by the yellow developing unit 204Y. Then, a toner image is formed on the surface of the photoreceptor drum 201Y. The toner composition may be composed of one component or two components. In the exemplary embodiment of the invention, the toner composition composed of two components is preferably used.

The toner image goes past a transfer region between the photoreceptor drum 201Y and the transfer delivery belt 206. Simultaneously therewith, a recording medium P is electrostatically adhered to the transfer delivery belt 206 and delivered to the transfer region. There, the toner image is, due to an electric field formed by a transfer bias applied from the transfer roll 207Y, sequentially transferred on an outer peripheral surface of the recording medium P.

Thereafter, toner remaining on the photoreceptor drum 201Y is cleaned and removed by a photoreceptor drum cleaner 205Y. Thereby, the photoreceptor drum 201Y is subjected to a next transfer cycle.

The transfer cycle mentioned above is similarly applied to image forming units 200M, 200C and 200Bk.

The recording medium P on which toner images are transferred by the transfer rolls 207Y, 207M, 207C and 207Bk is further delivered to fixing unit 209 to fix the images. Thereby, a desired image is formed on the recording medium

As the recording medium, usually, a sheet-like member made of a material having relatively high flexibility such as a paper recording medium (so-called sheet), a plastic film recording medium (so-called OHP sheet) or the like is used. However, when an image forming apparatus provided with a transfer delivery belt of the exemplary embodiment shown in FIG. 3 is used, a planar member made of a material having relatively high rigidity (such as a thick plastic card or the like) may also be used as a recording medium.

In the above, the electrophotographic image forming apparatus that uses an endless belt of the exemplary embodiment was described. However, the endless belt of the exemplary embodiment may be applied not only to electrophotographic image forming apparatuses, but also to known image forming apparatuses other than electrophotographic image forming apparatuses (such as an inkjet recording apparatus provided with a sheet delivery endless belt) as long as they mount at least one endless belt.

The image forming apparatus as described above is not limited to these embodiments, and can be configured to include various improvements, modifications and variations to the apparatus based on the knowledge a person skilled in the art, without departing from the scope of the invention.

### EXAMPLES

Hereinafter, although exemplary embodiments of the invention will be specifically described with reference to examples, it should be understood that the invention is not limited to these examples.

### Synthesis Example 1

4,4′-diamino diphenylether (hereinafter, abbreviated as “ODA”) (83.48 g (416.9 millimoles)) as a diamine compound is added to 800 g of N-metyl-2-pyrrolidone (hereinafter, abbreviated as “NMP”), and is dissolved by stirring at a normal temperature (25° C.). Subsequently, 116.52 g (396.0 millimole) of 3,3′,4,4′biphenyl tetracarboxylic dianhydride (hereinafter, abbreviated as “BPDA”) as a tetracarboxylic dianhydride is gradually added thereto. After the addition and dissolution of the tetracarboxylic dianhydride, the temperature of the reaction liquid is heated to 60° C., and the polymerization reaction is performed for 20 hours while maintaining the temperature of the reaction liquid at this temperature, and a reaction liquid containing a polyamic acid resin (A-1) and NMP is obtained. The obtained reaction liquid is filtered using a stainless steel mesh of #800, and is cooled to room temperature (25° C.), and a solution containing the polyamic acid resin (A-1) having a viscosity of 2.0 Pa·s at 25° C. is obtained. The viscosity is measured with the use of an E type rotary viscometer (trade name: TV-20H, manufactured by Toki Sangyo Co., Ltd.) with a standard rotor (cone angle: 1°34″×R24), under a measurement temperature of 25° C., and a rotation number of 0.5 rpm (100 or more Pa·s) or 1 rpm (less than 100 Pa·s). In the following Synthesis Examples, the measurement is carried out in a similar manner.

The composition of the polyamic acid resin (A-1) (BPDA/ODA) is 95/100 (mole/mole), and the polyamic acid resin (A-1) has a structure having amino groups at molecular terminal ends thereof.

### Synthesis Example 2

A solution with a viscosity of 6.0 Pa·s containing a polyamic acid resin (A-2) and NMP is obtained in a manner similar to Synthetic Example 1, except that 82.47 g (399.5 millimole) of ODA and 117.53 g (411.8 millimole) of BPDA are used.

The composition of the polyamic acid resin (A-2) (BPDA/ODA) is 97/100 (mole/mole), and the polyamic acid resin (A-2) has a structure having amino groups at molecular terminal ends thereof.

### Synthesis Example 3

A solution with a viscosity of 6.0 Pa·s containing a polyamic acid resin (A-3) and NMP is obtained in a manner similar to Synthetic Example 1 except that 79.57 g (397.4 millimole) of ODA and 120.43 g (409.3 millimole) of BPDA are used.

The composition of the polyamic acid resin (A-3) (BPDA/ODA) is 97/100 (mole/mole), and the polyamic acid resin (A-3) has a following structure:

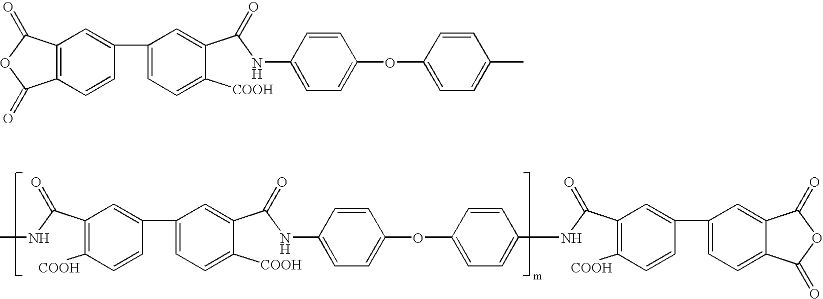

Preparation of Polyamic Acid Composition (B-1)

As a dried acidic carbon black used for an electrical conduction agent, 55.6 g of an oxidation treated carbon black (trade name: SPECIAL BLACK 4, manufactured by Evonik Degussa Co., Ltd., pH 4.0,volatile content 14.0%; (hereinafter, abbreviated as “SB-4”)) is gradually added to 1,000 g of the polyamic acid solution (A-1) obtained in Synthetic Example 1. After dispersing the carbon black in the polyamic acid solution with a ball mill at 30° C. for 12 hours, the dispersion is filtered through a stainless steel mesh #400, and a carbon-dispersed polyamic acid solution having the following composition is obtained. The obtained carbon-black-dispersed polyamic acid solution is used as a polyamic acid composition (B-1).

The composition of the polyamic acid composition (B-1) (polyamic acid resin (A-1) (BPDA/ODA)/NMP/CB) is 200/800/55.6 (ratio by weight).

Further, the composition ratio when the polyamic acid composition (B-1) is imidated, that is, the composition ratio of the polyimide film, in which carbon black is dispersed, prepared using the polyamic acid composition (B-1) (polyimide (BPDA/ODA)/carbon black (SB-4)) is 185.4/55.6 (ratio by weight). Accordingly, the ratio of carbon black/polyimide is 30.0/100 (ratio by weight).

Preparation of Polyamic Acid Compositions (B-2) and (B-3)

The polyamic acid compositions (B-2) and (B-3) are prepared in a manner similar to the preparation of the polyamic acid composition (B-1), except that the compounding ratio of SB-4 is changed as shown in Tables 1 and 2 in the preparation of the polyamic acid composition (B-1).

Preparation of Polyamic Acid Compositions (B-4) to (B-6)

The polyamic acid compositions (3-4) to (B-6) are prepared in a manner similar to the preparation of the polyamic acid composition (B-1), except that 1,000 g of the solution of polyamic acid (A-2) is used in place of 1,000 g of the solution of polyamic acid (A-1), and the compounding ratio of the carbon black SB-4 is changed as shown in Tables 1 and 2 in the preparation of the polyamic acid composition (B-1).

Preparation of Polyamic Acid Composition is (B-7) to (B-9)

The polyamic acid compositions (B-7) to (B-9) are prepared in a manner similar to the preparation of the polyamic acid composition (B-1), except that a nonacidic carbon black KETJENBLACK EC-300J (trade name, manufactured by Lion Akzo Co. Ltd., pH 9.0, volatile content 0.5%) is used in the quantities as shown in Tables 1 and 2 in place of carbon black SB-4 in the preparation of the polyamic acid composition (B-1).

Preparation of Polyamic Acid Compositions (B-10) to (B-12)

The polyamic acid compositions (B-10) to (B-12) are prepared in a manner similar to the preparation of the polyamic acid composition (B-1), except that 1,000 g of the solution of polyamic acid (A-3), in which an acid anhydride structure is the terminal end group, is used in place of 1,000 g of the solution of polyamic acid (A-1), and the carbon black SB-4 is used in the quantities as shown in Tables 3 and 4 in the preparation of the polyamic acid composition (B-1).

Preparation of Polyamic Acid Compositions (B-13) to (B-15)

The polyamic acid compositions (B-13) to (B-15) are prepared in a manner similar to the preparation of the polyamic acid composition (B-1), except that 1,000 g of the solution of polyamic acid (A-3), in which an acid anhydride structure is the terminal end group, is used in place of 1,000 g of the solution of polyamic acid (A-1), and a nonacidic carbon black KETJENBLACK EC-300J (trade name, manufactured by Lion Akzo Co. Ltd., pH value 9.0, volatile content 0.5%) is used in the quantities as shown in Tables 3 and 4 in place of the carbon black SB-4 in the preparation of the polyamic acid composition (B-1).

Preparation of Polyamic Acid Compositions (B-16) to (B-18)

The polyamic acid compositions (B-16) to (B-18) are prepared in a manner similar to the preparation of the polyamic acid composition (B-1), except that 1,000 g of the solution of polyamic acid (A-3), in which an acid anhydride structure is the terminal end group, is used in place of 1,000 g of the solution of polyamic acid (A-1), and a carbon black PRINTEX 150T (trade name, manufactured by Evonik Degussa Co., Ltd., pH 4.5, volatile content 10.0%) is used in the quantities as shown in Tables 3 and 4 in place of the carbon black SB-4 in the preparation of the polyamic acid composition (B-1).

The above compositions are indicated in Tables 1 to 3. In the following Tables 1 to 10, PAA represents polyamic acid, CB represents carbon black, NMP represents N-methyl-2-pyrrolidone, SB-4 represents an oxidation-treated CB (trade name. SPECIAL BLACK 4, manufactured by Degussa Japan Co., Ltd.; pH 4.0, volatile content 4.0%), 150T represents PRINTEX 150T (trade name, manufactured by Evonik Degussa Co., Ltd., pH 4.5, volatile content 10.0%), and EC300J represents KETJEN BLACK EC-300J (trade name, manufactured by Lion Akzo Co., Ltd., pH 9.0, volatile content 0.5%).

TABLE 1

| | | Polyamic Acid Composition | | | | | | | | | |
|---|---|---|---|---|---|---|---|---|---|---|---|
| | | (B-1) | | (B-2) | | (B-3) | | (B-4) | | (B-5) | |
| Compounding | Polyamic Acid | (A-1) | 200 | (A-1) | 200 | (A-1) | 200 | (A-2) | 200 | (A-2) | 200 |
| Ratio of | Resin | | | | | | | | | | |
| Polyamic Acid | Solvent | NMP | 800 | NMP | 800 | NMP | 800 | NMP | 800 | NMP | 800 |
| Composition | Carbon Black | SB-4 | 55.6 | SB-4 | 59.3 | SB-4 | 63.0 | SB-4 | 55.6 | SB-4 | 48.9 |
| | (CB) | | | | | | | | | | |

| | | | | | | |
|---|---|---|---|---|---|---|
| Composition of | Polyimide (PI) | 185.4 | 185.4 | 185.4 | 185.4 | 185.4 |
| CB-dispersed | Carbon Black | 55.6 | 59.3 | 63.0 | 55.6 | 48.9 |
| Polyimide Film | (CB) | | | | | |
| prepared from | CB/PI | 30.0/100 | 32.0/100 | 34.0/100 | 30.0/100 | 26.0/100 |
| Polyamic Acid | | | | | | |
| Composition | | | | | | |

TABLE 2

| | | Polyamic Acid Composition | | | | | | | |
|---|---|---|---|---|---|---|---|---|---|
| | | (B-6) | | (B-7) | | (B-8) | | (B-9) | |
| Compounding | Polyamic Acid | (A-2) | 200 | (A-1) | 200 | (A-1) | 200 | (A-1) | 200 |
| Ratio of | Resin | | | | | | | | |
| Polyamic Acid | Solvent | NMP | 800 | NMP | 800 | NMP | 800 | NMP | 800 |
| Composition | Carbon Black | SB-4 | 51.9 | EC300J | 55.6 | EC300J | 48.9 | EC300J | 51.9 |
| | (CB) | | | | | | | | |

| | | | | | |
|---|---|---|---|---|---|
| Composition of | Polyimide (PI) | 185.4 | 185.4 | 185.4 | 185.4 |
| CB-dispersed | Carbon Black | 51.9 | 55.6 | 48.9 | 51.9 |
| Polyimide Film | (CB) | | | | |
| prepared from | CB/PI | 28.0/100 | 30.0/100 | 26.0/100 | 28.0/100 |
| Polyamic Acid | | | | | |
| Composition | | | | | |

TABLE 3

| | | Polyamic Acid Composition | | | | | | | | | |
|---|---|---|---|---|---|---|---|---|---|---|---|
| | | (B-10) | | (B-11) | | (B-12) | | (B-13) | | (B-14) | |
| Compounding | Polyamic Acid | (A-3) | 200 | (A-3) | 200 | (A-3) | 200 | (A-3) | 200 | (A-3) | 200 |
| Ratio of | Resin | | | | | | | | | | |
| Polyamic Acid | Solvent | NMP | 800 | NMP | 800 | NMP | 800 | NMP | 800 | NMP | 800 |
| Composition | Carbon Black | SB-4 | 55.6 | SB-4 | 48.9 | SB-4 | 51.9 | EC300J | 55.6 | EC300J | 48.9 |
| | (CB) | | | | | | | | | | |

| | | | | | | |
|---|---|---|---|---|---|---|
| Composition of | Polyimide (PI) | 185.4 | 185.4 | 185.4 | 185.4 | 185.4 |
| CB-dispersed | Carbon Black | 55.6 | 48.9 | 51.9 | 55.6 | 48.9 |
| Polyimide Film | (CB) | | | | | |
| prepared from | CB/PI | 30.0/100 | 26.0/100 | 28.0/100 | 30.0/100 | 26.0/100 |
| Polyamic Acid | | | | | | |
| Composition | | | | | | |

TABLE 4

| | | Polyamic Acid Composition | | | | | | | |
|---|---|---|---|---|---|---|---|---|---|
| | | (B-15) | | (B-16) | | (B-17) | | (B-18) | |
| Compounding | Polyamic Acid | (A-3) | 200 | (A-1) | 200 | (A-1) | 200 | (A-1) | 200 |
| Ratio of | Resin | | | | | | | | |
| Polyamic Acid | Solvent | NMP | 800 | NMP | 800 | NMP | 800 | NMP | 800 |
| Composition | Carbon Black | EC300J | 48.9 | 150T | 55.6 | 150T | 59.3 | 150T | 63 |
| | (CB) | | | | | | | | |

| | | | | | |
|---|---|---|---|---|---|
| Composition of | Polyimide (PI) | 185.4 | 185.4 | 185.4 | 185.4 |
| CB-dispersed | Carbon Black | 48.9 | 55.6 | 59.3 | 63 |
| Polyimide Film | (CB) | | | | |
| prepared from | CB/PI | 26.0/100 | 30.0/100 | 32.0/100 | 34.0/100 |
| Polyamic Acid | | | | | |
| Composition | | | | | |

### Example 1

Manufacture of Polyimide Endless Belt (C-1)

The outer peripheral surface of a cylindrical substrate made of a stainless steel material having an outer diameter of 90 mm and a length of 450 mm is coated with a silicone releasing agent and then dried (releasing agent treatment). While the cylindrical substrate subjected to the releasing agent treatment is rotated at a speed of 10 rpm in a circumferential direction, a first coating solution (polyamic acid composition (B-1)) ejected from a dispenser with a diameter of 1 mm is coated on the cylindrical substrate from the end side thereof, with a metal blade mounted on the substrate being pressed to the coating solution at a uniform pressure. The first coating solution is spirally coated on the cylindrical substrate by moving a dispenser unit in the axial direction of the substrate at a speed of 100 mm/minute. After coating the first coating solution, the blade is released and the rotation of the cylindrical substrate is continued for 2 minutes for leveling.

Thereafter the substrate and the coated product are subjected to a drying treatment while rotating the same in an atmosphere of 150° C. for one hour in a drying oven. After drying, owing to the evaporation of solvent, the coated product changes to a polyamic acid resin molded product (endless belt main body) with a self-supporting property. After the drying treatment, subsequently, baking treatment is performed at 300° C. for 30 minutes in a clean oven, and the imidation reaction is progressed. Thereafter, the temperature of the substrate is 25° C., the polyimide resin is removed from the substrate, and a polyimide endless belt (C-1) is obtained.

### Examples 2 and 3

Manufacture of Polyimide Endless Belts (C-2) and (C-3)

Polyimide endless belts (C-2) and (C-3) are manufactured in a manner similar to Example 1, except that the layer thicknesses thereof are adjusted to 50 μm and 150 μm respectively by controlling the ejection volume from the dispenser and the moving velocity of the dispenser in Example 1.

### Examples 4 and 5

Manufacture of Polyimide Endless Belts (C-4) and (C-5)

Polyimide endless belts (C-4) and (C-5) are manufactured in a manner similar to Example 1, except that polyamic acid compositions (B-2) and (B-3) are respectively used as coating solutions in place of the polyamic acid composition (B-1) in Example 1.

### Examples 6 to 8

Manufacture of Polyimide Endless Belts (C-6) to (C-8)

Polyimide endless belts (C-6) to (C-8) are manufactured in a manner similar to Example 1, except that the layer thicknesses thereof are adjusted to 100 μm, 50 μm, and 150 μm respectively by using the polyamic acid composition (B-4) as coating solution in place of the polyamic acid composition (B-1) in Example 1.

### Examples 9 and 10

Manufacture of Polyimide Endless Belts (C-9) and (C-10)

Polyimide endless belts (C-9) and (C-10) are manufactured in a manner similar to Example 1, except that polyamic acid compositions (B-5) and (B-6) are respectively used as coating solutions in place of the polyamic acid composition (B-1) in Example 1.

### Examples 11 to 15

Manufacture of Polyimide Endless Belts (C-26) to (C-30)

Polyimide endless belts (C-26) to (C-30) are manufactured in a manner similar to Example 1, except that the layer thicknesses thereof are modified as shown in Table 7 by using the polyamic acid compositions (B-16) to (B-18) as coating solution respectively in place of the polyamic acid composition (B-1) in Example 1.

Evaluation of Polyimide Endless Belts

The polyimide endless belts obtained by Examples 1 to 15 are evaluated as follows. The results of the evaluation are shown in Tables 5 to 7.

Measurement of Layer Thickness

The layer thickness is measured by the above-mentioned method.

Measurement of Surface Resistivity

The surface resistivity ps is measured by the above-mentioned method.

When the values of the belt layer thickness and surface resistivity ps are substituted into Equation (C), the values of p and q calculated from the evaluation results of polyimide endless belts (C-1), (C-4) and (C-5), prepared in accordance with Examples 1, 4 and 6 using the polyamic acid compositions (B-1) to (B-3), are: p=−0,44 and q=25.10.

Further, the values of p and q calculated from the evaluation results of polyimide endless belts (C-6), (C-9) and (C-10), prepared in accordance with Examples 6, 9 and 10 using polyamic acid compositions (B-4) to (B-6), are p=−0.44 and q=25.10.

Furthermore, the values of p and q calculated from the evaluation results of polyimide endless belts (C-16), (C-17) and (C-18), prepared in accordance with Examples 11-15 using polyamic acid compositions (B-16) to (B-18), are p=−0.3 and q=25.

Measurement of Volume Resistivity

The volume resistivity of an obtained polyimide endless belt is measured by using a cylindrical electrode (trade name: UR probe of HIRESTER IP; manufactured by Mitsubishi Chemical Corporation; outer diameter Φ of cylindrical electrode: 16 mm; inner diameter Φ of ring-shaped electrode part: 30 mm; outer diameter Φ of ring-shaped electrode part: 40 mm) as an electrode for measurement. Specifically, a common-logarithm value of volume resistivity (ρv) is calculated from the current value, which is obtained by measuring the current value after applying a voltage of 100 V to the polyimide endless belt under an environment of 22° C./55% RH for 30 seconds. The results are shown in Tables 5 to 7.

The details of the method measuring of volume resistivity are as follows, To measure volume resistivity, an apparatus similar to that used for the measurement of the surface resistivity as shown in FIGS. 1A and 1B can be used. As shown in FIGS. 1A and 1B, the circular electrode used for measurement of surface resistivity has a first voltage application electrode A and a second voltage application electrode B. The first voltage application electrode A has a cylindrical electrode part C and a cylindrical ring-shaped electrode part D which has an inner diameter larger than the outer diameter of the cylindrical electrode part C and which surrounds the cylindrical electrode part C. A test sample, a polyimide endless belt T, is sandwiched between the second voltage application electrode B, and the cylindrical electrode part C and the ring-shaped electrode part D of the first voltage application electrode A. The volume resistivity ρv (Log Ω·cm) is obtained by the following Equation (E), by measuring current I(A), which flows when voltage V (V) is applied between the cylindrical electrode part C and the second voltage application electrode B of the first voltage application electrode A.

ρv=πd²/4t×(V/I) Equation (E)

In Equation (E), d (cm) represents the outer diameter of the cylindrical electrode part C. t (cm) represents the layer thickness of the polyimide endless belt T.

Measurement of Folding Endurance Number

The folding endurance number of the belt is measured by the above mentioned method. When the folding endurance number and the measured values of the layer thickness of the belt are substituted into Equations (A) and (B), the values of a and b, calculated from the evaluation results of polyimide endless belts (C-1) to (C-3), prepared in accordance with Examples 1 to 3 using polyamic acid composition (B-1), are a=−0.03667 and b=7.03260.

The values of a and b calculated from the evaluation results of polyimide endless belts (C-6) to (C-8), prepared in accordance with Examples 6 to 8 using polyamic acid compositions (B-4), are a=−0.03667 and b=7.02605, respectively.

The values of a and b calculated from the evaluation results of polyimide endless belts (C-26) to (C-28), prepared in accordance with Examples 11 to 13 using polyamic acid composition (B-16), are a=−0.036575 and b=7.89875.

Evaluation of Printed Image Quality

Among the produced polyimide endless belts, the initial characteristics of the polyimide endless belts (C-4), (C-9) and (C-29), having a layer thickness of 100 μm and a surface resistivity of in a range of from 11.1 to 11.8, are evaluated as follows:

The obtained polyimide endless belts are mounted as intermediate transfer belts to a modified copying machine processing speed: 250 mm/second; primary transfer current modified to 35 μA) of DocuCentre Color 2220 (trade name, manufactured by Fuji Xerox Co., Ltd.). Using this machine, 50% halftone cyan and magenta images are outputted onto C2 PAPER (trade name, manufactured by Fuji Xerox Co., Ltd.) under high-temperature and high-humidity conditions (28° C. and 85% RH), and under low-temperature and low-humidity conditions (10° C. and 15% RH), respectively. Unevenness of density and spot defects of the prints are visually evaluated in accordance with the following criteria. The results are shown in Tables 5 to 7.

Unevenness of Density

The printed area of the 10th printed sheet of print samples is cut into nine equal parts (3×3=9), and the chromaticity of each sample is measured using a chroma meter (trade name: CR-210, manufactured by Konica Minolta Co., Ltd.), and the color difference ΔE, which is a difference between the maximum chromaticity and the minimum chromaticity, is obtained. The following criteria are used:

A: Color difference ΔE is less than 0.3 (unevenness of density is not observed);

B: Color difference ΔE is 0.3 or more and less than 0.5;

C: Color difference ΔE is 0.5 or more and less than 1.0; and

D: Color difference ΔE is 1.0 or more.

Spot Defects

Spots within printed areas in the 10th sheet of printed samples are visually inspected and evaluated on the basis of the following criteria:

A: the number of spots with a size of less than 0.5 mm is less than 10;

B: the number of spots with a size of less than 0.5 mm is 10 or more and is less than 50;

C: the number of spots with a size of less than 0.5 mm is 50 or more and is less than 100, or the number of spots with a size of 0.5 mm or more and less than 1.0 is less than 50 and no spots with a size of 1.0 mm or more are found; and

D: the number of spots with a size of less than 0.5 mm is 100 or more, or the number of spots with a size of 0.5 mm or more and less than 50 mm is 50 or more, or the number of spots with a size of 1.0 mm or more is 1 or more.

Evaluation of Characteristics after Paper Feed Test

Measurements of layer thickness, surface resistivity, volume resistivity, belt breakage and folding endurance are performed following a paper feed test of 1000 sheets (after formation of 30% halftone images), and the measurement results are compared with those taken before the paper feed test.

TABLE 5

| | | Example 1 | | Example 2 | | Example 3 | | Example 4 | | Example 5 | |
|---|---|---|---|---|---|---|---|---|---|---|---|
| Prepared Polyimide Endless Belt | | (C-1) | | (C-2) | | (C-3) | | (C-4) | | (C-5) | |
| Coated Polyamic Acid Composition | | (B-1) | | (B-1) | | (B-1) | | (B-2) | | (B-3) | |
| Compounding | Polyamic | (A-1) | 200 | (A-1) | 200 | (A-1) | 200 | (A-1) | 200 | (A-1) | 200 |
| Ratio of Polyamic | Acid Resin | | | | | | | | | | |
| Acid Composition | Solvent | NMP | 800 | NMP | 800 | NMP | 800 | NMP | 800 | NMP | 800 |
| | Carbon | SB-4 | 55.6 | SB-4 | 55.6 | SB-4 | 55.6 | SB-4 | 59.3 | SB-4 | 63.0 |
| | Black (CB) | | | | | | | | | | |

| Compounding Ratio of | Polyimide | 185.4 | 185.4 | 185.4 | 185.4 | 185.4 |
|---|---|---|---|---|---|---|
| CB-dispersed | (PI) | | | | | |
| Polyimide Film | Carbon | 55.6 | 55.6 | 55.6 | 59.3 | 63.0 |
| prepared from Polyamic | Black (CB) | | | | | |
| Acid Composition | CB/PI | 30.0/100 | 30.0/100 | 30.0/100 | 32.0/100 | 34.0/100 |
| Initial Characteristics | | | | | | |
| Layer Thickness | (μm) | 100 | 50 | 150 | 100 | 100 |
| Surface Resistivity ρs | (logΩ/□) | 11.9 | 11.9 | 11.9 | 11.02 | 10.14 |
| Volume Resistivity ρv | (logΩ · cm) | 10.9 | 10.9 | 10.9 | 10.06 | 9.66 |
| log (FEₐᵥ): Value of Common- | | 3.36593 | 5.19927 | 1.5326 | 3.36599 | 3.36593 |
| logarithms of Average Value of | | | | | | |
| Folding Endurance (N = 10) | | | | | | |
| Print Quality | Density | — | — | — | A | — |
| | Unevenness | | | | | |
| | Spot Defects | — | — | — | A | — |
| Characteristics After Paper Feed | | | | | | |
| Layer Thickness | (μm) | — | — | — | 100 | — |
| Surface Resistivity ρs | (logΩ/□) | — | — | — | 11.02 | — |
| Volume Resistivity ρv | (logΩ · cm) | — | — | — | 11.06 | — |
| (FEₐᵥ): Average Value of Folding | | — | — | — | 3.366 | — |
| Endurance (Average of N = 10) | | | | | | |
| Belt Breakage | | — | — | — | None | — |
| Print Quality | Density | — | — | — | A | — |
| | Unevenness | | | | | |
| | Spot Defects | — | — | — | A | — |

TABLE 6

| | | Example 6 | | Example 7 | | Example 8 | | Example 9 | | Example 10 | |
|---|---|---|---|---|---|---|---|---|---|---|---|
| Prepared Polyimide Endless Belt | | (C-6) | | (C-7) | | (C-8) | | (C-9) | | (C-10) | |
| Coated polyamic Acid Composition | | (B-4) | | (B-4) | | (B-4) | | (B-5) | | (B-6) | |
| Compounding | Polyamic | (A-2) | 200 | (A-2) | 200 | (A-2) | 200 | (A-2) | 200 | (A-2) | 200 |
| Ratio of Polyamic | Acid Resin | | | | | | | | | | |
| Acid Composition | Solvent | NMP | 800 | NMP | 800 | NMP | 800 | NMP | 800 | NMP | 800 |
| | Carbon | SB-4 | 55.6 | SB-4 | 55.6 | SB-4 | 55.6 | SB-4 | 48.9 | SB-4 | 51.9 |
| | Black (CB) | | | | | | | | | | |

| Compounding Ratio of | Polyimide | 185.4 | 185.4 | 185.4 | 185.4 | 185.4 |
|---|---|---|---|---|---|---|
| CB-dispersed | (PI) | | | | | |
| PI Film prepared | Carbon | 55.6 | 55.6 | 55.6 | 48.9 | 51.9 |
| from Polyamic Acid | Black (CB) | | | | | |
| Composition | CB/PI | 30.0/100 | 30.0/100 | 30.0/100 | 26.0/100 | 28.0/100 |
| Initial Characteristics | | | | | | |
| Layer Thickness | (μm) | 100 | 50 | 150 | 100 | 100 |
| Surface Resistivity ρs | (logΩ/□) | 12 | 12 | 12 | 11.1 | 10.2 |
| Volume Resistivity ρv | (logΩ · cm) | 10.85 | 10.85 | 10.85 | 10.02 | 9.68 |
| log (FEₐᵥ): Value of Common- | | 3.35939 | 5.19272 | 1.52605 | 3.35942 | 3.3541 |
| logarithms of Average Value of | | | | | | |
| Folding Endurance (N = 10) | | | | | | |
| Print Quality | Density | — | — | — | A | — |
| | Unevenness | | | | | |
| | Spot Defects | — | — | — | A | — |
| Characteristics After Paper Feed | | | | | | |
| Layer Thickness | (μm) | — | — | — | — | — |
| Surface Resistivity ρs | (logΩ/□) | — | — | — | — | — |
| Volume Resistivity ρv | (logΩ · cm) | — | — | — | — | — |
| (FEₐᵥ): Average Value of Folding | | — | — | — | | — |
| Endurance (Average of N = 10) | | | | | | |
| Belt Breakage | | — | — | — | None | — |
| Print Quality | Density | — | — | — | A | — |
| | Unevenness | | | | | |
| | Spot Defects | — | — | — | A | — |

TABLE 7

| | | Example 11 | | Example 12 | | Example 13 | | Example 14 | | Example 15 | |
|---|---|---|---|---|---|---|---|---|---|---|---|
| Prepared Polyimide Endless Belt | | (C-26) | | (C-27) | | (C-28) | | (C-29) | | (C-30) | |
| Coated polyamic Acid Composition | | (B-16) | | (B-16) | | (B-16) | | (B-17) | | (B-18) | |
| Compounding | Polyamic | (A-1) | 200 | (A-1) | 200 | (A-1) | 200 | (A-1) | 200 | (A-1) | 200 |
| Ratio of Polyamic | Acid Resin | | | | | | | | | | |
| Acid Composition | Solvent | NMP | 800 | NMP | 800 | NMP | 800 | NMP | 800 | NMP | 800 |
| | Carbon | 150T | 55.6 | 150T | 55.6 | 150T | 55.6 | 150T | 59.3 | 150T | 63 |
| | Black (CB) | | | | | | | | | | |

| Compounding Ratio | Polyimide | 185.4 | 185.4 | 185.4 | 185.4 | 185.4 |
|---|---|---|---|---|---|---|
| of CB-dispersed | (PI) | | | | | |
| PI Film prepared | Carbon | 55.6 | 55.6 | 55.6 | 59.3 | 63 |
| from Polyamic Acid | Black (CB) | | | | | |
| Composition | CB/PI | 30.0/100 | 30.0/100 | 30.0/100 | 32.0/100 | 34.0/100 |
| Initial Characteristics | | | | | | |
| Layer Thickness | (μm) | 50 | 100 | 150 | 100 | 100 |
| Surface Resistivity ρs | (logΩ/□) | 16 | 16 | 16 | 15.4 | 14.4 |
| Volume Resistivity ρv | (logΩ · cm) | 14 | 14 | 14 | 14.5 | 12.2 |
| log (FEₐᵥ): Value of Common- | | 6.07 | 4.2402 | 2.4125 | 4.2561 | 4.2561 |
| logarithms of Average Value of | | | | | | |
| Folding Endurance (N = 10) | | | | | | |
| Print Quality | Density | — | — | — | A | — |
| | Unevenness | | | | | |
| | Spot Defects | — | — | — | A | — |
| Characteristics After Paper Feed | | | | | | |
| Layer Thickness | (μm) | — | — | — | 100 | — |
| Surface Resistivity ρs | (logΩ/□) | — | — | — | 11.6 | — |
| Volume Resistivity ρv | (logΩ · cm) | — | — | — | 10.06 | — |
| (FEₐᵥ): Average Value of Folding | | — | — | — | 3.366 | — |
| Endurance (Average of N = 10) | | | | | | |
| Belt Breakage | | — | — | — | None | — |
| Print Quality | Density | — | — | — | B | — |
| | Unevenness | | | | | |
| | Spot Defects | — | — | — | B | — |

### Comparative Examples 1 to 3

Manufacture of Polyimide Endless Belts (C-11) to (C-13)

Polyimide endless belts (C-11) to (C-13) are manufactured in a manner similar to Example 1, except that the layer thicknesses thereof are adjusted to 100 μm, 50 μm, and 150 μm respectively by using the polyamic acid composition (B-7) as coating solution in place of the polyamic acid composition (B-1) in Example 1.

### Comparative Examples 4 and 5

Manufacture of Polyimide Endless Belts (C-14) and (C-15)

Polyimide endless belts (C-14) and (C-15) are manufactured in a manner similar to Example 1, except that the polyamic acid compositions (B-8) and (B-9) are respectively used as coating solutions in place of the polyamic acid composition (B-1) in Example 1.

### Comparative Examples 6 to 8

Manufacture of Polyimide Endless Belts (C-16) to (C-18)

Polyimide endless belts (C-16) to (C-18) are manufactured in a manner similar to Example 1, except that the layer thicknesses thereof are adjusted to 100 μm, 50 μm, and 150 μm respectively by using the polyamic acid composition (B-10) as coating solution in place of the polyamic acid composition (B-1) in Example 1.

### Comparative Examples 9 and 10

Manufacture of Polyimide Endless Belts (C-19) and (C-20)

Polyimide endless belts (C-19) and (C-20) are manufactured in a manner similar to Example 1, except that the polyamic acid compositions (B-11) and (B-12) are respectively used as coating solutions in place of the polyamic acid composition (B-1) in Example 1.

### Comparative Examples 11 to 13

Manufacture of Polyimide Endless Belts (C-21) to (C-23)

Polyimide endless belts (C-21) to (C-23) are manufactured in a manner similar to Example 1, except that the layer thicknesses thereof are adjusted to 100 μm, 50 μm, and 150 μm respectively by using the polyamic acid composition (B-13) as coating solution in place of the polyamic acid composition (B-1) in Example 1.

### Comparative Examples 14 and 15

Manufacture of Polyimide Endless Belts (C-24) and (C-25)

Polyimide endless belts (C-24) and (C-25) are manufactured in a manner similar to Example 1, except that the polyamic acid compositions (B-14) and (B-15) are respectively used as coating solutions in place of the polyamic acid composition (B-1) in Example 1.

The layer thickness, surface resistivity, volume resistivity and folding endurance number of the polyimide endless belts (C-11) to (C-25) obtained in Comparative Examples 1 to 15 are evaluated in a manner similar to Example 1.

When the folding endurance number and the measured values of the layer thickness of the belt are substituted into Equations (A) and (B), the values of a and b calculated from the evaluation results of polyimide endless belts (C-11) to (C-13), prepared in accordance with Comparative Examples 1 to 3 using polyamic acid composition (B-7), are a=−0.03667 and b=6.72817.

The values of a and b calculated from the evaluation results of polyimide endless belts (C-16) to (C-18), prepared in accordance with Comparative Examples 6 to 8 using polyamic acid compositions (B-10), axe a=−0.03667 and b=6.30735.

The values of a and b calculated from the evaluation results of polyimide endless belts (C-21) to (C-23), prepared in accordance with Comparative Examples 11 to 13 using polyamic acid composition (B-13), are a=−0.036575 and b=6.65333.

When the values of the layer thickness of the belt and the surface resistivity ps are substituted into Equation (C), the values of p and q calculated from the evaluation results of polyimide endless belts (C-11), (C-14) and (C-15), prepared in accordance with Comparative Examples 1, 4 and 6 using the polyamic acid compositions (B-7) to (B-9), are p=−0.48 and q=24.50.

Further, the values of p and q calculated from the evaluation results of polyimide endless belts (C-16), (C-19) and (C-20), prepared in accordance with Comparative Examples 6, 9 and 10 using polyamic acid compositions (B-10) to (B-12), are p=−0.42 and q=24.50.

Furthermore, the values of p and q calculated from the evaluation results of polyimide endless belts (C-21), (C-24) and (C-25), prepared in accordance with Comparative Examples 11, 14 and 15 using polyamic acid compositions (B-13) to (B-15), are p=−0.42 and q=23.80.

Evaluation of Printed Image Quality

The following polyimide endless belts are respectively mounted to an electrophotographic apparatus in a manner similar to Example 1, and printed images using the same are evaluated: a polyimide endless belt (C-15) which has a surface resistivity in the range of from 11.0 to 11.5, and a layer thickness of 100 μm, and is manufactured from a polyamic acid (A-1) with amino groups at terminal ends thereof and a polyamic acid composition (B-9) comprising KETJEN BLACK EC-300J (described above); a polyimide endless belt (C-16) which is manufactured from a polyamic acid (A-3) with an acid anhydride structure at terminal ends thereof and a polyamic acid composition (B-10) comprising an acidic carbon black; and a polyimide endless belt (C-21) which is manufactured from a polyamic acid (A-3) with an acid anhydride structure at terminal ends thereof and a polyamic acid composition (B-13) comprising KETJEN BLACK EC-300J (described above). The evaluation results are shown in Tables 8 to 10.

TABLE 8

| | | Comparative | | Comparative | | Comparative | | Comparative | | Comparative | |
|---|---|---|---|---|---|---|---|---|---|---|---|
| | | Example 1 | | Example 2 | | Example 3 | | Example 4 | | Example 5 | |
| Prepared Polyimide Endless Belt | | (C-11) | | (C-12) | | (C-13) | | (C-14) | | (C-15) | |
| Coated polyamic Acid Composition | | (B-7) | | (B-7) | | (B-7) | | (B-8) | | (B-9) | |
| Compounding | Polyamic Acid | (A-1) | 200 | (A-1) | 200 | (A-1) | 200 | (A-1) | 200 | (A-1) | 200 |
| Ratio of Polyamic | Resin | | | | | | | | | | |
| Acid Composition | Solvent | NMP | 800 | NMP | 800 | NMP | 800 | NMP | 800 | NMP | 800 |
| | Carbon Black | EC300J | 55.6 | EC300J | 55.6 | EC300J | 55.6 | EC300J | 48.9 | EC300J | 51.9 |
| | (CB) | | | | | | | | | | |

| Compounding Ratio | Polyimide | 185.4 | 185.4 | 185.4 | 185.4 | 185.4 |
|---|---|---|---|---|---|---|
| of CB-dispersed | (PI) | | | | | |
| Polyimide Film | Carbon Black | 55.6 | 55.6 | 55.6 | 48.9 | 51.9 |
| prepared from | (CB) | | | | | |
| Polyamic Acid | CB/PI | 30.0/100 | 30.0/100 | 30.0/100 | 26.0/100 | 28.0/100 |
| Composition | | | | | | |
| Initial Characteristics | | | | | | |
| Layer Thickness | (μm) | 100 | 50 | 150 | 100 | 100 |
| Surface Resistivity ρs | (logΩ/□) | 10.1 | 10.08 | 10.08 | 12.02 | 11.06 |
| Volume Resistivity ρv | (logΩ · cm) | 9.56 | 9.55 | 9.43 | 10.48 | 9.82 |
| log (FEₐᵥ): Value of Common- | | 3.0615 | 4.89484 | 1.22817 | 3.06148 | 3.06152 |
| logarithms of Average Value of | | | | | | |
| Folding Endurance (N = 10) | | | | | | |
| Print Quality | Density | — | — | — | — | C |
| | Unevenness | | | | | |
| | Spot Defects | — | — | — | — | C |
| Characteristics After Paper Feed | | | | | | |
| Layer Thickness | (μm) | 100 | 100 | 100 | 100 | 100 |
| Surface Resistivity ρs | (logΩ/□) | — | — | — | — | 9.84 |
| Volume Resistivity | (logΩ · cm) | — | — | — | — | 7.88 |
| ρv | | | | | | |
| (FEₐᵥ): Average Value of Folding | | — | — | — | — | 2.44665 |
| Endurance (Average of N = 10) | | | | | | |
| Belt Breakage | | — | — | — | — | Present |
| Print Quality | Density | — | — | — | | D |
| | Unevenness | | | | | |
| | Spot Defects | — | — | — | | D |

TABLE 9

| | | Comparative | | Comparative | | Comparative | | Comparative | | Comparative | |
|---|---|---|---|---|---|---|---|---|---|---|---|
| | | Example 6 | | Example 7 | | Example 8 | | Example 9 | | Example 10 | |
| Prepared Polyimide Endless Belt | | (C-16) | | (C-17) | | (C-18) | | (C-19) | | (C-20) | |
| Coated polyamic Acid Composition | | (B-10) | | (B-10) | | (B-10) | | (B-11) | | (B-12) | |
| Compounding | Polyamic Acid | (A-3) | 200 | (A-3) | 200 | (A-3) | 200 | (A-3) | 200 | (A-3) | 200 |
| Ratio of Polyamic | Resin | | | | | | | | | | |
| Acid Composition | Solvent | NMP | 800 | NMP | 800 | NMP | 800 | NMP | 800 | NMP | 800 |
| | Carbon Black | SB-4 | 55.6 | SB-4 | 55.6 | SB-4 | 55.6 | SB-4 | 48.9 | SB-4 | 51.9 |
| | (CB) | | | | | | | | | | |

| Compounding Ratio | Polyimide | 185.4 | 185.4 | 185.4 | 185.4 | 185.4 |
|---|---|---|---|---|---|---|
| of CB-dispersed | (PI) | | | | | |
| Polyimide Film | Carbon Black | 55.6 | 55.6 | 55.6 | 48.9 | 51.9 |
| prepared from | (CB) | | | | | |
| Polyamic Acid | CB/PI | 30.0/100 | 30.0/100 | 30.0/100 | 26.0/100 | 28.0/100 |
| Composition | | | | | | |
| Initial Characteristics | | | | | | |
| Layer Thickness | (μm) | 100 | 50 | 150 | 100 | 100 |
| Surface Resistivity ρs | (logΩ/□) | 11 | 11.05 | 10.98 | 12.8 | 11.9 |
| Volume Resistivity ρv | (logΩ · cm) | 10.05 | 10.03 | 9.82 | 11.66 | 10.82 |
| log (FEₐᵥ): Value of Common- | | 2.64068 | 4.47401 | 0.80735 | 2.6407 | 2.64066 |
| logarithms of Average Value of | | | | | | |
| Folding Endurance (N = 10) | | | | | | |
| Print Quality | Density | B | — | — | — | — |
| | Unevenness | | | | | |
| | Spot Defects | B | — | — | — | — |
| Characteristics After Paper Feed | | | | | | |
| Layer Thickness | (μm) | 100 | 100 | 100 | 100 | 100 |
| Surface Resistivity ρs | (logΩ/□) | 10.23 | — | — | — | — |
| Volume Resistivity | (logΩ · cm) | 9.45 | — | — | — | — |
| ρv | | | | | | |
| (FEₐᵥ): Average Value of Folding | | 1.84635 | — | — | — | — |
| Endurance (Average of N = 10) | | | | | | |
| Belt Breakage | | Present | — | — | | — |
| Print Quality | Density | C | — | — | — | — |
| | Unevenness | | | | | |
| | Spot Defects | C | — | — | — | — |

TABLE 10

| | | Comparative | | Comparative | | Comparative | | Comparative | | Comparative | |
|---|---|---|---|---|---|---|---|---|---|---|---|
| | | Example 11 | | Example 12 | | Example 13 | | Example 14 | | Example 15 | |
| Prepared Polyimide Endless Belt | | (C-21) | | (C-22) | | (C-23) | | (C-24) | | (C-25) | |
| Coated polyamic Acid Composition | | (B-13) | | (B-13) | | (B-13) | | (B-14) | | (B-14) | |
| Compounding | Polyamic Acid | (A-3) | 200 | (A-3) | 200 | (A-3) | 200 | (A-3) | 200 | (A-3) | 200 |
| Ratio of Polyamic | Resin | | | | | | | | | | |
| Acid Composition | Solvent | NMP | 800 | NMP | 800 | NMP | 800 | NMP | 800 | NMP | 800 |
| | Carbon Black | SB-4 | 55.6 | EC300J | 55.6 | EC300J | 55.6 | EC300J | 48.9 | EC300J | 48.9 |
| | (CB) | | | | | | | | | | |

| Compounding Ratio | Polyimide | 185.4 | 185.4 | 185.4 | 185.4 | 185.4 |
|---|---|---|---|---|---|---|
| of CB-dispersed | (PI) | | | | | |
| Polyimide Film | Carbon Black | 55.6 | 55.6 | 55.6 | 48.9 | 48.9 |
| prepared from | (CB) | | | | | |
| Polyamic Acid | CB/PI | 30.0/100 | 30.0/100 | 30.0/100 | 26.0/100 | 26.0/100 |
| Composition | | | | | | |
| Initial Characteristics | | | | | | |
| Layer Thickness | (μm) | 100 | 50 | 150 | 100 | 100 |
| Surface Resistivity ρs | (logΩ/□) | 11.2 | 11.18 | 11.16 | 12.88 | 12.04 |
| Volume Resistivity ρv | (logΩ · cm) | 9.68 | 9.58 | 9.44 | 10.63 | 10.22 |
| log (FEₐᵥ): Value of Common- | | 2.98666 | 4.81999 | 1.15334 | 2.998662 | 2.98656 |
| logarithms of Average Value of | | | | | | |
| Folding Endurance (N = 10) | | | | | | |
| Print Quality | Density | C | — | — | — | — |
| | Unevenness | | | | | |
| | Spot Defects | C | — | — | — | — |
| Characteristics After Paper Feed | | | | | | |
| Layer Thickness | (μm) | 100 | 100 | 100 | 100 | 100 |
| Surface Resistivity ρs | (logΩ/□) | 9.56 | — | — | — | — |
| Volume Resistivity | (logΩ · cm) | 7.22 | — | — | — | — |
| ρv | | | | | | |
| (FEₐᵥ): Average Value of Folding | | 1.89732 | — | — | — | — |
| Endurance (Average of N = 10) | | | | | | |
| Belt Breakage | | Present | — | — | | — |
| Print Quality | Density | D | — | — | — | — |
| | Unevenness | | | | | |
| | Spot Defects | D | — | — | — | — |

What is claimed is:

1. A polyamic acid composition in which carbon black with a pH value of approximately 7 or less is dispersed in a solution comprising a polyamic acid represented by the following Formula (1) having amino groups at molecular terminal ends thereof; and a solvent: 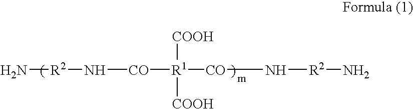
wherein R¹ represents a tetravalent organic group, R² represents a divalent organic group, and m represents an integer of 1 or more.

2. The polyamic acid composition of claim 1, wherein R¹ in Formula (1) is a residual structure in which four carboxylic acid groups are removed from a tetracarboxylic acid compound represented by the following Formula (2):

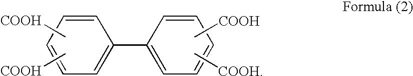

3. The polyamic acid composition of claim 1, wherein R¹ in Formula (1) has a structure selected from following Formulae (2-1) to (2-5):

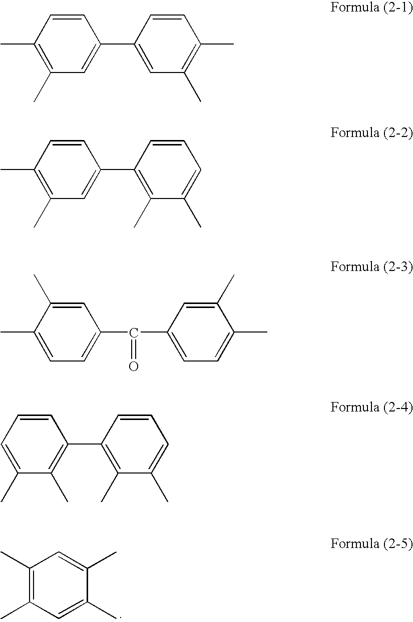

4. The polyamic acid composition of claim 1, wherein R² in Formula (1) has a structure selected from following Formulae (3-1) to (3-7);

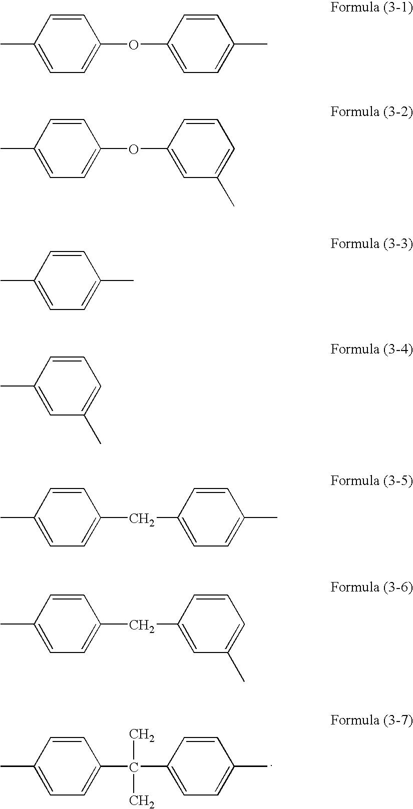

5. A method of producing a polyimide endless belt, the method comprising:
coating a polyamic acid composition onto the surface of a cylindrical substrate; and
converting at least a part of a polyamic acid structure in the polyamic acid composition into an imide by a heating treatment,
the polyamic acid composition being a polyamic acid composition in which carbon black with a pH value of approximately 7 or less is dispersed in a solution comprising a polyamic acid represented by the following Formula (1) having amino groups at molecular terminal ends thereof, and a solvent: 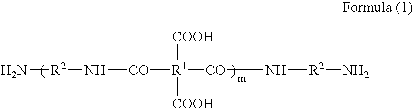
wherein R¹ represents a tetravalent organic group, R² represents a divalent organic group, and m represents an integer of 1 or more.

6. A polyimide endless belt produced by a method, the method comprising:
coating a polyamic acid composition onto the surface of a cylindrical substrate; and
converting at least a part of a polyamic acid structure in the polyamic acid composition into an imide by a heating treatment, and
the polyamic acid composition being a polyamic acid composition in which carbon black with a pH value of approximately 7 or less is dispersed in a solution comprising a polyamic acid represented by the following Formula (1) having amino groups at the molecular terminal ends thereof, and a solvent: 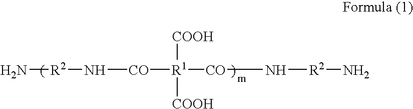
wherein R¹ represents a tetravalent organic group, R² represents a divalent organic group, and m represents an integer of 1 or more.

7. The polyimide endless belt of claim 6, wherein folding endurance of the polyimide endless belt satisfies the following Equations (A) and (B);
FE=log ₁₀N Equation (A):
FEₐᵥ=ad+b Equation (B):
wherein FE represents folding endurance, N represents a number of times that a test piece cut off from the polyimide endless belt is bent reciprocally until it breaks, measured under conditions of a tensile load of 1.0 Kg and a bending angle of 135° by an MIT tester, FEₐᵥ represents an average FE of ten of the test pieces, d represents an average layer thickness (μm) of the ten test pieces and is from about 50 to about 150, a is from approximately −0.03667 to approximately −0.03650, and b is approximately 6.78 or more.

8. The polyimide endless belt of claim 6, wherein a compounding amount (C) (parts by weight) of the carbon black with a pH value of approximately 7 or less with respect to 100 parts of a polyimide resin contained in the polyimide endless belt, and a surface resistivity ρs (log Ω/□) at 25° C. of an outer peripheral surface of the polyimide endless belt satisfy Equation (C):
ρs=pC+q Equation (C):
wherein p is from approximately −0.48 to approximately −0.42, q is from approximately 25 to approximately 33, ρs is from approximately 8 to approximately 14, and C is from approximately 20 to approximately 40.

9. An image forming apparatus having a polyimide endless belt produced by a method comprising:
coating a polyamic acid composition onto the surface of a cylindrical substrate; and
converting at least a part of a polyamic acid structure in the polyamic acid composition into an imide by a heating treatment, and
the polyamic acid composition being a polyamic acid composition in which carbon black with a pH value of approximately 7 or less is dispersed in a solution comprising a polyamic acid represented by the following Formula (1) having amino groups at molecular terminal ends thereof, and a solvent: 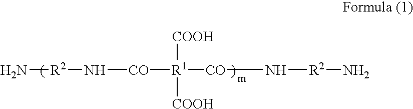
wherein R¹ represents a tetravalent organic group, R² represents a divalent organic group, and m represents an integer of 1 or more.

10. The image forming apparatus of claim 9, wherein the polyimide endless belt is an intermediate transfer belt, a transfer belt, delivery belt, or a fixing belt.

11. The image forming apparatus of claim 9, wherein the image forming apparatus comprises:
an image holding member;
a charging unit that charges a surface of the image holding member;
an exposing unit that exposes a surface of the image holding member to form an electrostatic latent image;
a developing unit that develops the electrostatic latent image formed on the surface of the image holding member with a developing agent to form a toner image; and
a transfer unit that transfers the toner image formed on the surface of the image holding member onto a recording medium, and
the transfer unit comprises:
a primary transfer unit that transfers the toner image formed on the surface of the image holding member onto an outer peripheral surface of an intermediate transfer medium; and
a secondary transfer unit that transfers the toner image formed on the outer peripheral surface of an intermediate transfer medium onto the recording medium, and
the intermediate transfer medium is the polyimide endless belt.
